(19) United States
(12) Patent Application Publication
(10) Pub. No.: US 2026/0342563 A1
(43) Pub. Date: Oct. 29, 2026

(54) KEY-ROLLING METHOD FOR SLIDING-WINDOW BASED ORDER RELAXATION

(71) Applicant: Hewlett Packard Enterprise Development LP, Spring, TX (US)

(72) Inventors: Derek Alan Sherlock, Ft. Collins, CO (US); Frank R. Dropps, Annandale, MN (US); Keith D. Underwood, Powell, TN (US)

(21) Appl. No.: 19/346,129

(22) Filed: Sep. 30, 2025

Related U.S. Application Data
(60) Provisional application No. 63/795,769, filed on Apr. 28, 2025.
(60) Provisional application No. 63/795,807, filed on Apr. 28, 2025.

(51) Int. Cl. H04L 9/08

(52) U.S. Cl. CPC H04L 9/0891

(57) ABSTRACT

A requester identifies a sliding window associated with: a plurality of active epochs corresponding to a time window in which a predetermined number of requests are allowed to be sent; and at least one inactive epoch corresponding to a time window in which requests are not allowed to be sent. The requester obtains encryption keys associated with encryption of roundtrip communications with a responder. The requester generates an initial value (IV) associated with the encryption, the IV comprising a current epoch value. The requester determines that the current epoch value differs from an epoch value used in a previously sent request and advances the sliding window. Responsive to the current epoch value matching a key-rolling value, the requester rolls the encryption keys. The requester sends, to the responder, a first request encrypted based on an obtained key associated with the current epoch value and indicating part of the IV.

### RELATED APPLICATION

This application claims the benefit of U.S. Provisional Patent Application No. 63/795,769, Attorney Docket Number P177460USPRV, entitled “SLIDING-WINDOW BASED ORDER RELAXATION FOR ENCRYPTED CHANNEL,” by Derek Alan Sherlock, Frank R. Dropps, and Keith D. Underwood, filed on 28 Apr. 2025.

### BACKGROUND

Some developing network fabric specifications use an encryption protocol that requires in-order delivery of messages. For example, the AES-GCM-256 protocol uses a shared key and an initial value (IV) for each encryption operation. The key may be used repeatedly, and is refreshed periodically to reduce vulnerability to attacks. In addition, reusing the IV with the same key may weaken security.

### BRIEF DESCRIPTION OF THE FIGURES

FIG. 1 illustrates an environment which facilitates a key-rolling method for sliding-window based order relaxation, in accordance with an aspect of the present application.

FIG. 2A illustrates a bit-field chart depicting a full IV maintained by a requester, based on a four-epoch implementation of a multi-epoch sliding window, in accordance with an aspect of the present application.

FIG. 2B illustrates a bit-field chart depicting a partial IV maintained by a responder, based on a four-epoch implementation of a multi-epoch sliding window, in accordance with an aspect of the present application.

FIG. 2C illustrates a diagram of hardware or data structures maintained by a requester, based on a four-epoch implementation of a multi-epoch sliding window, in accordance with an aspect of the present application.

FIG. 2D illustrates a diagram of hardware or data structures maintained by a responder, based on a four-epoch implementation of a multi-epoch sliding window, in accordance with an aspect of the present application.

FIG. 2E presents a flowchart illustrating operations by a requester in sending requests, based on a four-epoch implementation of a multi-epoch sliding window, in accordance with an aspect of the present application.

FIG. 2F presents a flowchart illustrating operations by a requester in receiving a response, based on a four-epoch implementation of a multi-epoch sliding window, in accordance with an aspect of the present application.

FIG. 2G presents a flowchart illustrating operations by a responder in receiving a request, based on a four-epoch implementation of a multi-epoch sliding window, in accordance with an aspect of the present application.

FIG. 2H presents a flowchart illustrating operations by a responder in sending a response, based on a four-epoch implementation of a multi-epoch sliding window, in accordance with an aspect of the present application.

FIG. 3 illustrates a diagram of operations, including key-rolling operations, by a requester and a responder, based on a four-epoch implementation of a multi-epoch sliding window, in accordance with an aspect of the present application.

FIG. 4A illustrates a bit-field chart depicting a full IV maintained by a requester, based on a two-epoch implementation of a multi-epoch sliding window with fine-grained state tracking, in accordance with an aspect of the present application.

FIG. 4B illustrates a bit-field chart depicting a partial IV maintained by a responder, based on a two-epoch implementation of a multi-epoch sliding window with fine-grained state tracking, in accordance with an aspect of the present application.

FIG. 4C illustrates a diagram of hardware or data structures maintained by a requester, based on a two-epoch implementation of a multi-epoch sliding window with fine-grained state tracking, in accordance with an aspect of the present application.

FIG. 4D illustrates a diagram of hardware or data structures maintained by a responder, based on a two-epoch implementation of a multi-epoch sliding window with fine-grained state tracking, in accordance with an aspect of the present application.

FIG. 4E illustrates a diagram of a first state machine with four states maintained by a requester and a second state machine with two states maintained by a responder, based on a two-epoch implementation of a multi-epoch sliding window with fine-grained state tracking, in accordance with an aspect of the present application.

FIG. 5A presents a flowchart illustrating operations by a requester in sending requests, based on a two-epoch implementation of a multi-epoch sliding window with fine-grained state tracking, in accordance with an aspect of the present application.

FIG. 5B presents a flowchart illustrating operations by a requester in receiving a response, based on a two-epoch implementation of a multi-epoch sliding window with fine-grained state tracking, in accordance with an aspect of the present application.

FIG. 5C presents a flowchart illustrating operations by a responder in receiving a request, based on a two-epoch implementation of a multi-epoch sliding window with fine-grained state tracking, in accordance with an aspect of the present application.

FIG. 5D presents a flowchart illustrating operations by a responder in sending a response, based on a two-epoch implementation of a multi-epoch sliding window with fine-grained state tracking, in accordance with an aspect of the present application.

FIG. 6 illustrates a diagram of operations, including key-rolling operations, by a requester and a responder, based on a two-epoch implementation of a multi-epoch sliding window with fine-grained state tracking, in accordance with an aspect of the present application.

FIG. 7 presents a flowchart illustrating a key-rolling method for sliding-window based order relaxation, in accordance with an aspect of the present application.

FIG. 8 illustrates a computing system which facilitates a key-rolling method for sliding-window based order relaxation, in accordance with an aspect of the present application.

FIG. 9 illustrates a computer-readable medium which facilitates a key-rolling method for sliding-window based order relaxation, in accordance with an aspect of the present application.

In the figures, like reference numerals refer to the same figure elements.

### DETAILED DESCRIPTION

Aspects of the present application provide a system which facilitates a key-rolling method for sliding-window based order relaxation.

As described above, some developing network fabric specifications use an encryption protocol that requires in-order delivery of messages. For example, the AES-GCM-256 protocol uses a shared key and an initial value (IV) for each encryption operation. The key may be used repeatedly, and is refreshed periodically (also referred to as “key-rolling” or a “key roll”) to reduce vulnerability to attacks. In addition, reusing the IV with the same key may weaken security.

In some current solutions, key-rolling methods may require in-order delivery of requests (sent by either the requester or the responder) to synchronize use of a new shared key for encrypted roundtrip communications. The requester may generate and transmit the IV in plaintext to the responder, resulting in full-length IV transmission. However, the transmission of full-length IV values with every request message may incur significant bandwidth overhead. Alternatively, the IV may be maintained by both the requester and the responder as a synchronized counter, which also requires in-order message delivery. However, in-order delivery may consume extra network resources or unacceptably constrain the use of multiple parallel network paths, especially in large-scale high-performance computing (HPC) or Artificial Intelligences (AI) networks.

The described aspects address the limitations associated with required in-order delivery by providing a key-rolling method that does not require in-order delivery or the transmission of full-length IV values. The key-rolling method may be applied based on a sliding window and two techniques: a “multi-epoch system”; and a “multi-epoch system with fine-grained state tracking (FGST).” A sliding window may be associated with two or more “epochs,” corresponding to a time window in which a maximum number of requests may be sent. An “active” epoch may correspond to a time window in which the maximum number of requests are allowed to be sent, and an “inactive” epoch may correspond to a time window in which requests are not allowed to be sent. In this disclosure, a four-epoch system is used as an illustrative example of a multi-epoch system, and a two-epoch system is used as an illustrative example of a FGST multi-epoch system. These examples do not limit the invention; each system as described may include more than four epochs (in the case of the multi-epoch system) or more than two epochs (in the case of the FGST multi-epoch system). The aspects of the processes, operations, methods, techniques, and examples described in this disclosure can work with any number of epochs, which may be understood by any person of ordinary skill in the art. Furthermore, the described aspects may be used in a high-performance interconnect technology, e.g., Ultra Accelerator Link (“UALink”). UALink is an open-standard, high-performance interconnect technology designed to scale AI accelerators and switches within a “pod” of high-capacity computing resources and to enable the pods to function as a unified large processing unit for demanding AI and HPC workloads. UALink can provide the high bandwidth, low latency, and memory-sharing capabilities necessary to train and run complex AI models by connecting multiple accelerators (e.g., a graphics processing unit (GPU), a tensor processing unit (TPU), or an application-specific integrated circuit (ASIC)) with unified memory. UALink may be optimized for the unique communication patterns of AI workloads, including direct memory access (DMA) and atomic operations. UALink may further support scaling from a few accelerators to large configurations, with the option to connect multiple pods using other technologies like Ultra Ethernet for broader scale-out architectures.

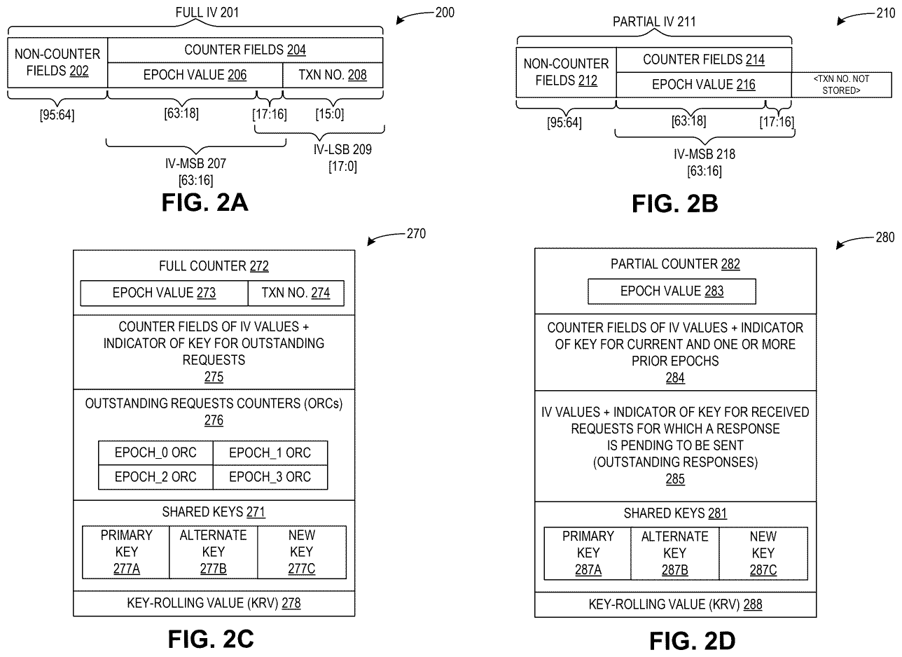

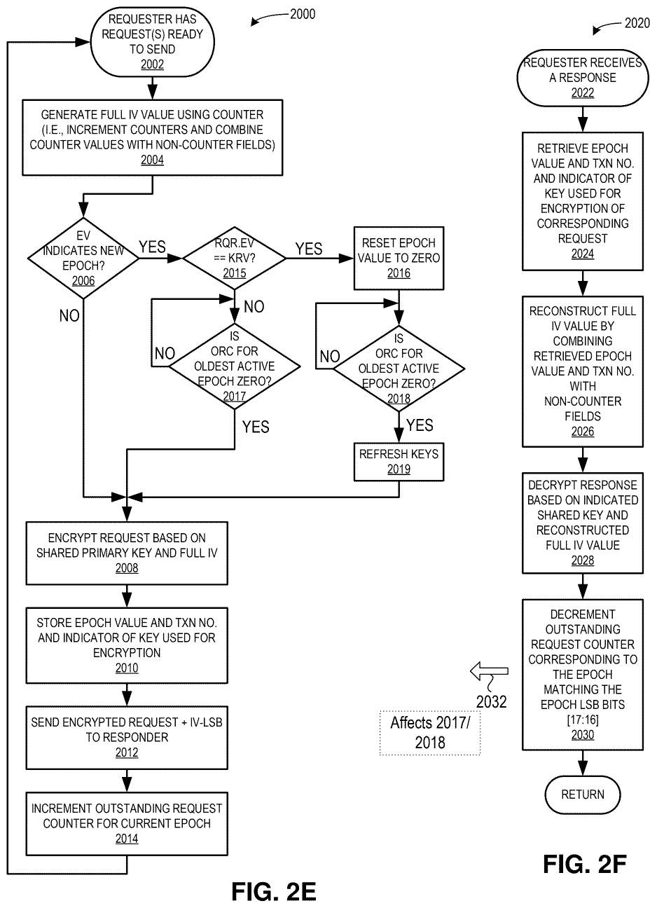

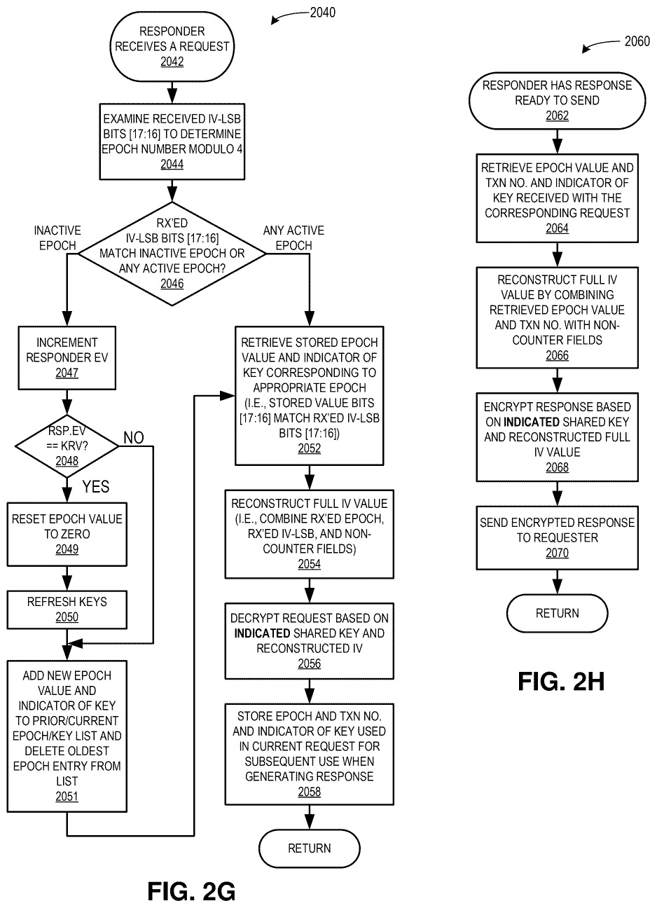

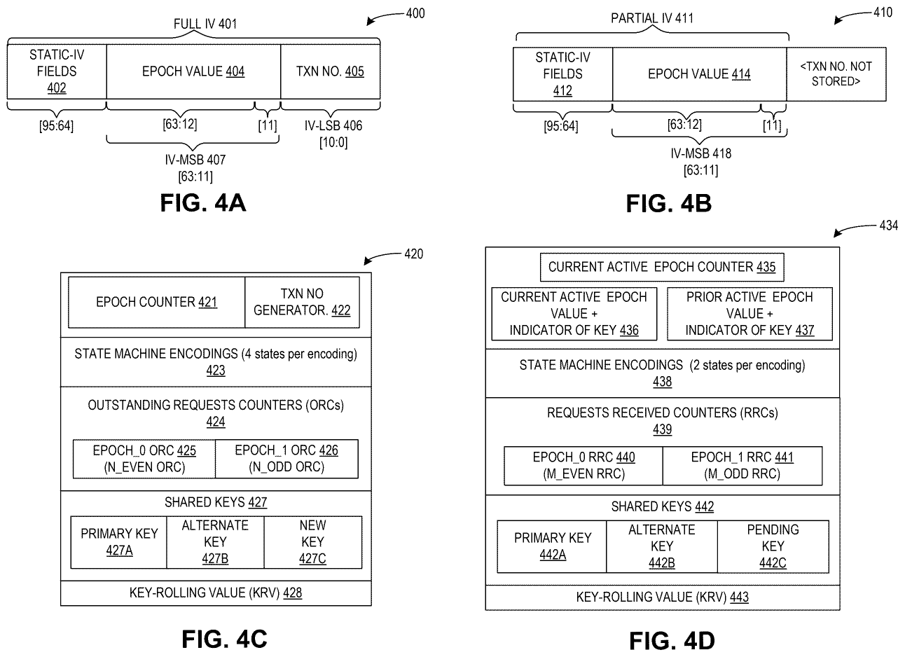

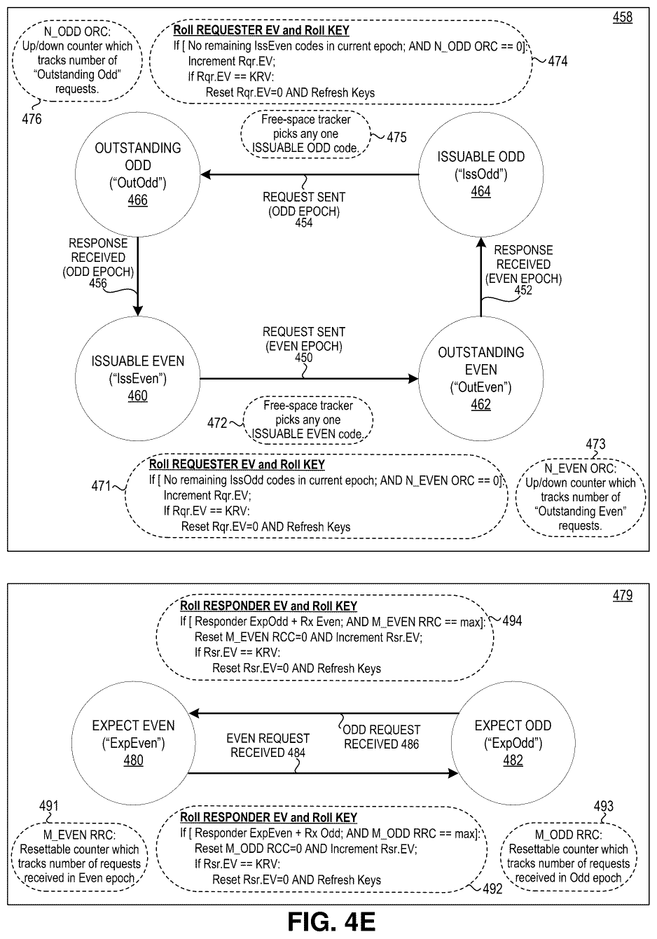

The requester and the responder may each generate and maintain the full IV or a portion of the IV. A subset of bits of the IV may carry an “epoch value,” where each epoch represents a time window in which a maximum number of requests may be sent, and the requester and responder may each maintain their own respective version of the epoch value, which are coordinated using the two techniques as described herein. The requester or responder may increment its respective epoch value at the start of each epoch (based on various conditions using the two techniques described herein. When the requester or responder increments its respective epoch value, the sliding window advances, activating the next inactive epoch and deactivating the oldest active epoch (“epoch roll”). Subsequent to an epoch roll, if the new epoch value matches a pre-agreed “key-rolling value,” the requester or responder can also “roll” the keys (i.e., perform a “key roll”). The requester and the responder may each maintain or obtain a same set of keys, based on cryptographic mechanisms known in the art, including but not limited to, e.g.: asymmetric key exchange algorithms; pre-shared symmetric keys using secure out-of-band distribution, a key management system, a hardware security module, or a trusted third party; and public key certificates. Exemplary keys and key usage are described below in relation to FIGS. 2C-D and 3 (for the multi-epoch system) and FIGS. 4C-E and 6 (for the FGST multi-epoch system). This mechanism ensures that each request/response is associated with the correct epoch and key+IV, without requiring strict in-order delivery. The key-rolling method is described below in relation to the two techniques.

In the first technique (multi-epoch system), a requester and a responder can continue to use a shared key and a common initial value (IV) for encrypted communication, but instead of transmitting the full IV, the requester may transmit (e.g., in cleartext) only a subset of the IV, such as the least significant bits (LSBs) of the IV (IV-LSB). The responder may reconstruct the full IV by combining the received IV-LSB with its own counter value corresponding to the most significant bits (MSBs) of the IV (IV-MSB). An exemplary multi-epoch system (a four-epoch system where the sliding window is associated with three active epochs and one inactive epoch) is described below in relation to FIGS. 2A-H and 3.

In the second technique (FGST multi-epoch system), the requester and responder can also continue to use a shared key and a common IV for encrypted communication. However, instead of sending the full IV with each request, the requester transmits a request with only a subset of the full IV, such as a number of the least significant bits (LSBs) (IV-LSB), in a protocol layer header field (the “Tag” field), while the responder may reconstruct the full IV by combining the received IV-LSB with its own counter which tracks the remaining most significant bits (IV-MSB). This Tag field may already be included as part of the protocol-layer header and thus does not require any additional bits to be transmitted in the roundtrip communications between the requester and the responder. As a result, this “Tag for IV-LSB approach” may reduce bandwidth overhead by transmitting less IV data while allowing for out-of-order message delivery. The Tag for IV-LSB approach may also be used in the first technique, e.g., the requester may transmit the subset of the bits of the IV in the protocol Tag field, instead of in cleartext.

Furthermore, in the second technique, both the requester and the responder may use certain bits of the IV-MSB as an “epoch identifier” (also referred to as “epoch-identifying bits”), which define a time window for a predetermined number of requests. For example, using the least significant bit of the IV-MSB as the epoch identifier in a “two-epoch system” along with the state machine described below in relation to FIG. 4E, the requester may manage a sliding window associated with two “active epochs.” In the two-epoch system, the requester may identify and advance a sliding window with two epochs based on a set of conditions, and requests and responses may be exchanged across two active epochs simultaneously. An exemplary FGST multi-epoch system (a two-epoch system where the sliding window is associated with two active epochs at the same time) is described below in relation to FIGS. 4A-E, 5A-D, and 6.

In both the first and second techniques, the responder may encrypt its response using the shared key and reconstructed IV, without transmitting any IV bits back, which allows the requester and responder to use almost the same IV for encryption/decryption and ensure that their respective counters remain in sync while only the requester transmits only a portion of the full IV. Because an IV value should never be repeated for the same encryption key, the IV value used by the requester and responder will differ by a high order IV bit. For example, the MSB of the IV may be “0” for requester encryption and responder decryption and may be “1” for responder encryption and requestor decryption. This arrangement may be understood by both the requester and responder, thereby eliminating the need to exchange this information.

There is no loss in functionality or security if any other IV bit is selected or if the information is exchanged.

In both the first technique and the second technique, the requester and the responder may determine or agree upon the key-rolling value. In some aspects, the requester and the responder may exchange messages in order to dynamically configure, change, or update the key-rolling value.

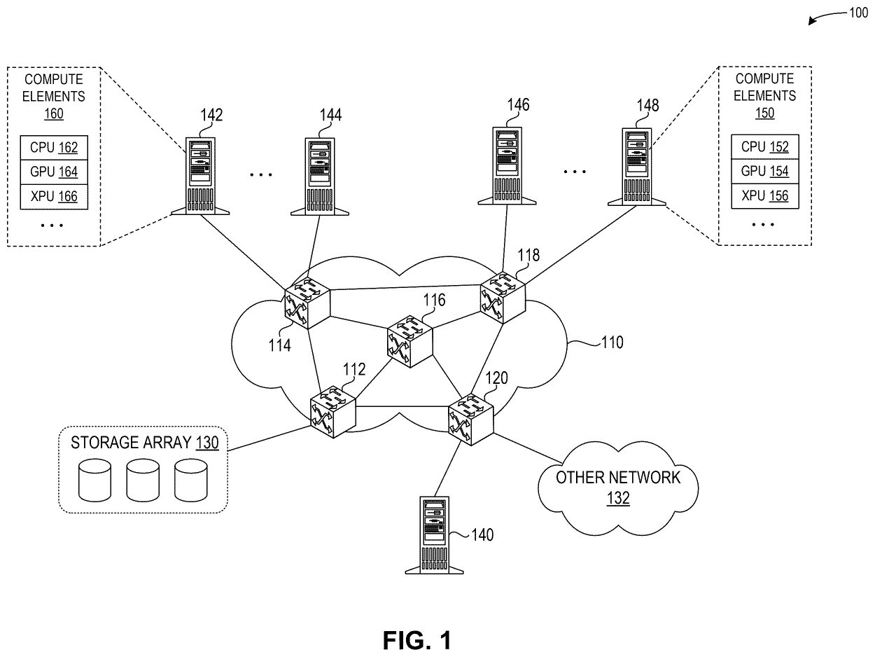

FIG. 1 illustrates an environment 100 which facilitates sliding-window based order relaxation for an encrypted channel, in accordance with an aspect of the present application. Environment 100 can include a network 110 of switches which can be referred to as a “switch fabric” or a “network fabric” and can include switches 112, 114, 116, 118, and 120. Each switch can have a unique address or identifier within switch fabric 110. Various types of endpoints, processing nodes, devices, and networks can be coupled to a switch fabric. For example, a storage array 130 may be coupled to switch fabric 110 via switch 112. An other network 132 (e.g., an HPC, Ethernet, InfiniBand, or any other network) may be coupled to switch fabric 110 via switch 120. Other network 132 may include multiple networked computer and storage devices concurrently running programs to complete different complex and performance-intensive tasks. Other network 132 may include physical Ethernet cabling and an application layer protocol between network devices based on Internet Protocol (IP), including communication via Transport Communication Protocol (TCP)/IP and User Datagram Protocol (UDP) packets. Switch fabric 110 may itself be an Ethernet network or an HPC network.

Any number of endpoints, processing nodes, compute elements, or devices with compute elements (collectively referred to as “devices”) may also be coupled to switch fabric 110, e.g.: devices 142 and 144 may be coupled to switch fabric 110 via switch 114; devices 146 and 148 may be coupled to switch fabric 110 via switch 118; and device 140 may be coupled to switch fabric 110 via switch 120. As depicted in FIG. 1, device 148 may include compute elements 150, which may include, e.g.: a central processing unit (CPU) 152; a graphics processing unit (GPU) 154; and an XPU 156, which may be any processing unit, combination of processing units, or specialized processing unit or hardware accelerator designed or optimized for a specific task. Similarly, device 142 may include compute elements 160, which may include, e.g., a CPU 162, a GPU 164, and an XPU 166. Environment 100 may include more or fewer entities coupled to switch fabric 110, and each device may include more or fewer compute elements than those depicted in compute elements 150. The entities coupled to switch fabric 110 may include a requesting node (“requester”) and a responder node (“responder”). A requester may engage in roundtrip communications over a secure encrypted channel with a responder, where each request sent by the requester expects a corresponding response from the responder. Requests and responses may flow between CPU/GPU/XPU blocks in different nodes, e.g., between 162/164/166 CPU/GPU/XPU in node 142 and 152/154/156 CPU/GPU/XPU in node 148.

In general, a switch can have edge ports and fabric ports. An edge port can couple to a device that is external to the fabric. A fabric port can couple to another switch within the fabric via a fabric link. Typically, traffic may be injected into switch fabric 110 via an ingress port of an edge switch and may leave switch fabric 110 via an egress port of another (or the same) edge switch. An ingress link can couple a NIC of an edge device (e.g., an HPC end host) to an ingress edge port of an edge switch. Switch fabric 110 can then transport the traffic to an egress edge switch, which in turn can deliver the traffic to a destination edge device via another NIC. In some aspects, an ingress or egress edge port may attach directly to a network-capable component such as a GPU or XPU without any intervening NIC. A packet can be forwarded in switch fabric 110 based on its Layer-2 address (“fabric address”), which may be viewed as an equivalent to a media access control (MAC) address in Ethernet. The forwarding path for the packet may be determined based on adaptive forwarding, e.g., based on local programming of the switches in switch fabric 110 and information related to load, traffic, and congestion available to and associated with switch fabric 110.

### First Key-Rolling Technique: Multi-Epoch System (e.g., Four-Epoch System)

FIG. 2A illustrates a bit-field chart 200 depicting a full IV 201 maintained by a requester, based on a four-epoch implementation of a multi-epoch sliding window, in accordance with an aspect of the present application. The requester may generate full IV 201. Full IV 201 may be generated by or based on a cipher counter (e.g., a Galois counter) and may contain a varying number of bits. For example, full IV 201 may include 96 bits, such as: non-counter fields 202 [95:64]; and counter fields 204 [63:0], which includes an epoch value 206 [63:16] and a transaction number 208 [15:0]. The requester epoch value 206 may also be referred to as IV-MSB 207 [63:16]. Non-counter fields 202 may include information used by the requester, responder, or other intermediate entity, to process a message associated with full IV 201.

Counter fields 204 may be used to identify the number of requests with sequentially numbered IV-LSBs which have been sent by the requester. In addition, transaction number 208 may indicate LSBs [15:0] of full IV 201, while IV-LSB 209 [17:0] may include these transaction number LSBs [15:0] as its LSBs and may also include the LSBs [17:16] of epoch value 206 as its MSBs. These MSBs [17:16] of IV-LSB 209 [17:0] may be referred to as “epoch-identifying bits” because they may be used to unambiguously distinguish the epochs of outstanding transactions, from among the three currently active epochs (in a four-epoch system). Active epochs may be sequentially numbered, allowing epochs to be distinguished based on their modulo-4 epoch value (contained in bits [17:16] of the IV, i.e., the LSB bits [17:16] of epoch value 206).

FIG. 2B illustrates a bit-field chart 210 depicting a partial IV 211 maintained by a responder, based on a four-epoch implementation of a multi-epoch sliding window, in accordance with an aspect of the present application. The responder may maintain partial IV 211, which can include: non-counter fields 212 [95:64]; and counter fields 214, which can include an epoch value 216 [63:16]. The responder epoch value 216 may include as its LSBs epoch-identifying bits [17:16]. The responder epoch value 216 may also be referred to as IV-MSB 218 [63:16]. The responder does not track the count of each transaction number. The bit ranges listed for partial IV 211 are listed without the bottom 16 bits in order to describe the synchronization of the counter values between the requester and the responder. The actual number of bits used to store partial IV 211 may be less than the highest numbered bit depicted for partial IV 211 (e.g., listed as 95, but maintained as 95−16=79).

FIG. 2C illustrates a diagram 270 of hardware or data structures maintained by a requester, based on a four-epoch implementation of a multi-epoch sliding window, in accordance with an aspect of the present application. The requester may include in its hardware: a full counter 272, which can generate an epoch value 273 and a transaction number 274; counter fields (e.g., 204) of IV values and an indicator of the key used for outstanding requests 275, i.e., a mechanism to track the counter fields of IV values and key used on each outstanding request/transaction sent by the requester for which a response is still pending; and outstanding requests counters (ORCs) 276 which track the number of requests sent by the requester which are still awaiting a response; ORCs 276 may include an ORC for each epoch. For example, in a four-epoch system, ORCs 276 may include an epoch_0 ORC, an epoch_1 ORC, an epoch_2 ORC, and an epoch_3 ORC. Each ORC may be associated with an ORC value. Since, in this example, outstanding transactions at any given time may only exist in up three consecutively-numbered epochs, the epoch numbers of concurrently outstanding transactions may disambiguated by their modulo-4 value, of the two LSBs of the epoch number contained in bits [17:16] of the IV. As such, four ORCs may be sufficient for the requester to track the counts of all outstanding transactions.

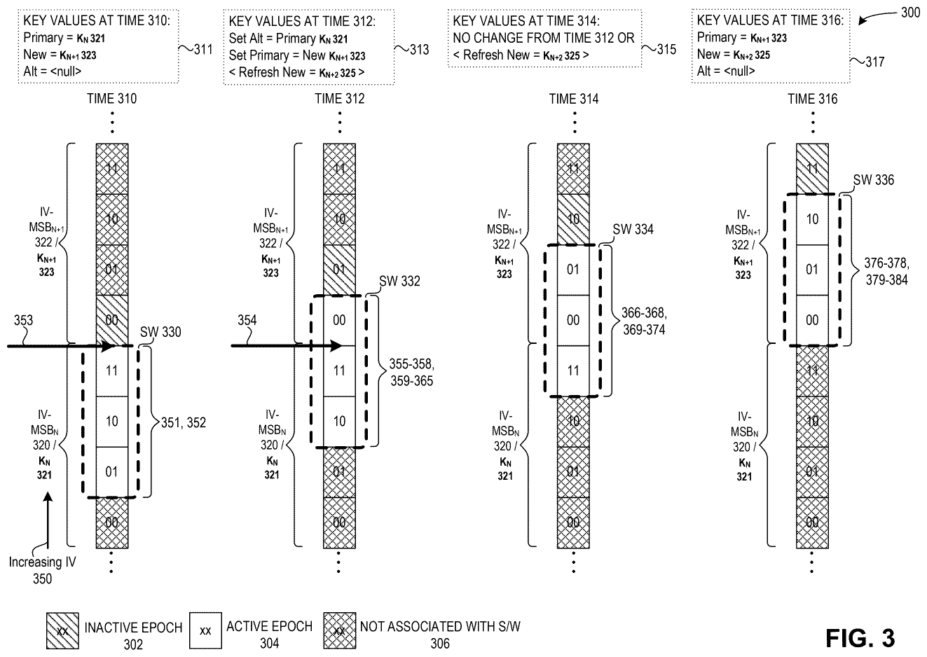

The requester may also include in its hardware: shared keys 271, which can include a primary key 277A, an alternate key 277B, and a new key 277C; and a key-rolling value (KRV) 278. Primary key 277A may be associated with a most recent active epoch; alternate key 277B may be associated with an oldest active epoch; and new key 277C may be associated with a currently inactive epoch. When the requester determines that a key roll is to be performed (e.g., based on the requester epoch value 273 reaching KRV 278), the system: sets the primary key to a current value of the new key; sets the alternate key to a current value of the primary key; and sets the new key to a new value. The indicator of the key used (275) may reference either primary key 277A or alternate key 277B. New key 277C may serve as a placeholder or storage for the next key, which value may be assigned to the primary key as part of a key roll (as described in relation to 313 in FIG. 3).

FIG. 2D illustrates a diagram 280 of hardware or data structures maintained by a responder, based on a four-epoch implementation of a multi-epoch sliding window, in accordance with an aspect of the present application. The responder may include in its hardware: a partial counter 282, which can generate an epoch value 283 (e.g., indicated as bits [63:16] in FIG. 2B); counter fields of IV values and an indicator of the key used for the current and one or more prior epochs 284 (also referred to as “prior epoch values”); and IV values and an indicator of the key used for received requests for which a response is pending to be sent 285 (also referred to as “outstanding responses”).

The responder may also include in its hardware: shared keys 281, which can include a primary key 287A, an alternate key 287B, and a new key 287C; and a key-rolling value (KRV) 288. Similar to shared keys 277A, 277B, and 277C maintained by the requester: primary key 287A may be associated with a most recent active epoch; alternate key 287B may be associated with an oldest active epoch; and new key 287C may be associated with a currently inactive epoch. When the responder determines that a key roll is to be performed (e.g., based on the responder epoch value 283 reaching KRV 288), the system: sets the primary key to a current value of the new key; sets the alternate key to a current value of the primary key; and sets the new key to a new value. The indicator of the key used (284/285) may reference either primary key 287A or alternate key 287B.

FIG. 2E presents a flowchart 2000 illustrating operations by a requester in sending requests, based on a four-epoch implementation of a multi-epoch sliding window, in accordance with an aspect of the present application. The operations by the requester may begin when the requester has a request (or requests) to send (2002).

The requester generates the full IV value using the counter (operation 2004). That is, the requester increments counters and combines the counter values with the non-counter fields, as described above in relation to FIG. 2A and full IV 201 comprising non-counter fields 202 and counter fields 204.

The requester determines whether its requester epoch value (EV) indicates that a new epoch is in use (decision 2006). A new epoch may be indicated by a change in epoch value 273 resulting from a carry from transaction number field 274 during the increment operation 2004. If the requester EV does not indicate that a new epoch is in use (decision 2006), the operation continues at operation 2008. If the requester EV does indicate that a new epoch is in use (decision 2006), the requester determines whether the requester EV (“Rqr.EV”) is equal to the key-rolling value (KRV) (decision 2015).

If the requester EV is equal to the KRV (decision 2015), the requester resets its EV to zero (operation 2016). If the ORC for the oldest active epoch is not zero (decision 2018) (i.e., there exists at least one outstanding request in the oldest active epoch), the operation returns to decision 2018 and waits for responses to decrement the ORC until the ORC for the oldest active epoch is zero. If the ORC for the oldest active epoch is zero (decision 2018) (i.e., no more outstanding requests exist in the oldest active epoch), the requester refreshes the key (operation 2019) (i.e., performs a key roll), and the operation continues at operation 2008. As described above in relation to shared keys 271 of FIG. 2C, refreshing the key or performing the key roll may include: setting the primary key to a current value of the new key; setting the alternate key to a current value of the primary key; and setting the new key to a new value.

If the requester EV is not equal to the KRV (decision 2015), the system determines whether the ORC for the oldest active epoch is zero (decision 2017). If it is not zero (decision 2017), the operation returns to decision 2017 and waits for responses to decrement the ORC until the ORC for the oldest active epoch is zero. If it is zero (decision 2017), the operation continues at operation 2008.

The ORC for a plurality of epochs may be stored by the requester, e.g., as described above in relation to ORCs 276 in FIG. 2C, indicating one ORC for each epoch. The oldest active epoch becomes inactive, and the new epoch along with the prior two epochs may be referred to as the active epochs. Transactions may only be outstanding in the active epochs. Thus, decisions 2017 and 2018 may represent a blocking action which does not unblock until all outstanding requests have received a corresponding response.

The requester encrypts the request based on the shared primary key and the full IV (operation 2008). The requester stores the epoch value and transaction number and indicator of the key used for encryption of the request (operation 2010). The epoch value, transaction number, and indicated key may be used by the requester for subsequent decryption of the corresponding response, e.g., the counter fields of IV values and indicator of key used for outstanding requests 285 as stored and described above in relation to FIG. 2C. The requester sends the encrypted request, along with the IV-LSB (e.g., in cleartext or in the Tag protocol field) to the responder (operation 2012), and the requester may increment its outstanding request counter for the current epoch (operation 2014). Flowchart 2000 is depicted as a loop because individual iterations are not independent, i.e., when the requester blocks the sending of additional requests at decisions 2017 and 2018, both current request sending and all future request sending is blocked.

FIG. 2F presents a flowchart 2020 illustrating operations by a requester in receiving a response, based on a four-epoch implementation of multi-epoch sliding window, in accordance with an aspect of the present application. Responses for outstanding transactions may be received in any order, independent of the order in which the corresponding requests were sent. The operations by the requester may begin when the requester receives a response (2022). The requester retrieves the epoch value and transaction number and indicator of the key used for encryption of the corresponding request (operation 2024), e.g., as stored in 285 of FIG. 2C. The requester reconstructs the full IV value by combining the retrieved epoch value and transaction number with the non-counter fields (operation 2026). For example, the requester may retrieve the previously stored epoch value and transaction number for the request corresponding to the received response from 275 in FIG. 2C. The requester may also use non-counter fields 202 (as depicted in full IV 201 in FIG. 2A) to reconstruct the full IV.

The requester decrypts the response based on the indicated shared key and the reconstructed full IV (operation 2028), and the requester decrements the ORC corresponding to the epoch matching the epoch LSB bits [17:16] (operation 2030). For example, the requester may decrement the ORC for epoch_2 as stored in ORCs 276 in FIG. 2C. If the response happens to match the final outstanding transaction in the oldest active epoch, then the action of decrementing the ORC for the appropriate epoch to zero may end a pause or blocking performed by the requester as part of decisions 2017 and 2018 (as indicated by 2032). Flowchart 2020 is depicted as a linear flow rather than a loop (as in flowchart 2000) because each received response may have an independent flow. In contrast to sending requests, sequential dependency does not exist between received responses.

FIG. 2G presents a flowchart 2040 illustrating operations by a responder in receiving a request, based on a four-epoch implementation of a multi-epoch sliding window, in accordance with an aspect of the present application. The operations by the responder may begin when the responder receives a request (2042). Requests may be received by the responder in a different order versus the order they were sent by the requester. The request may be encrypted based on a shared key and a full IV, and the request may include the IV-LSB in cleartext. The responder examines the received IV-LSB bits [17:16] to determine an epoch number modulo 4 (operation 2044). For example: if the two bits are “00,” this corresponds to an epoch 0; if the two bits are “01,” this corresponds to an epoch 1; if the two bits are “10,” this corresponds to an epoch 2; and if the two are “11,” this corresponds to an epoch 3. Moving between states with certain active and inactive epochs in a four-epoch system is described below in relation to FIG. 3.

The responder determines whether the received IV-LSB bits [17:16] match an inactive epoch or any active epoch (decision 2046). If the received IV-LSB bits match an inactive epoch (decision 2046), the responder may determine that an epoch roll has occurred, i.e., the responder has received a request whose IV-LSB bits indicate a modulo-4 epoch number that does not correspond to one of the currently active epochs. As a result, the responder increments its responder epoch counter (operation 2047).

The responder determines whether the responder EV (“Rsp.EV”) is equal to the key-rolling value (KRV) (decision 2048). If the responder EV Is not equal to the KRV (decision 2048), the operation continues at operation 2051. If the responder EV is equal to the KRV (decision 2048), the responder resets its responder EV to zero (operation 2049) and refreshes the keys (operation 2050), similar to the key roll operation performed by the requester in operation 2019 of FIG. 2E. For example, as described above in relation to shared keys 281 of FIG. 2D, refreshing the key or performing the key roll may include: setting the primary key to a current value of the new key; setting the alternate key to a current value of the primary key; and setting the new key to a new value.

The responder adds the new epoch value and indicator of the key used to the prior/current epoch/key list (e.g., 284 in FIG. 2D) and deletes the oldest epoch entry from that list (operation 2051, as depicted above in relation to 284 in FIG. 2D). The operation continues at operation 2052.

If the received IV-LSB bits match any active epoch (decision 2046), the responder may determine that an epoch roll has not occurred. The responder retrieves the stored epoch value and indicator of the key corresponding to the appropriate epoch (operation 2052), i.e., the epoch value for which the stored value bits [17:16] match the IV-LSB bits [17:16] received in the request. The responder reconstructs the full IV (operation 2054), i.e., by combining the received epoch value, the received IV-LSB, and the non-counter fields. The responder decrypts the request based on the indicated shared key and the reconstructed IV (operation 2056). The responder stores the epoch value and transaction number and indicator of the key used in decrypting the current request for subsequent use when generating a response to the request (operation 2058), as described above in relation to 285 in FIG. 2D. The operation returns. Flowchart 2040 is depicted as a linear flow rather than a loop (as in flowchart 2000) because there are neither sequential dependencies nor implied orderings between distinct transactions, or between request order and response order.

FIG. 2H presents a flowchart 2060 illustrating operations by a responder in sending a response, based on a four-epoch implementation of a multi-epoch sliding window, in accordance with an aspect of the present application. Responses may be sent by the responder in a different order versus the order the corresponding requests were received. The operations by the responder may begin when the responder has a response ready to send to the requester (2062). The responder retrieves the epoch value and transaction number received and indicator of the key used with the corresponding request (operation 2064), e.g., as previously stored in 285 in FIG. 2D as part of operation 2058. The responder reconstructs the full IV by combining the retrieved epoch value and transaction number with the non-counter fields (operation 2066). For example, the responder may retrieve the previously stored epoch value and transaction number for the response from 285 in FIG. 2D. The responder may also use non-counter fields 212 (as depicted in partial IV 211 in FIG. 2B) to reconstruct the full IV.

The responder encrypts the response based on the indicated shared key and the reconstructed full IV value (operation 2068) and sends the encrypted response (without any IV-LSB in cleartext) to the requester (operation 2070). That is, the responder does not include the IV-LSB in the response. The operation returns. Flowchart 2060 is depicted as a linear flow rather than a loop (as in flowchart 2000) because there are neither sequential dependencies nor implied orderings between distinct transactions, or between request order and response order.

FIG. 3 illustrates a diagram 300 of operations, including key-rolling operations, by a requester and a responder, based on a four-epoch implementation of a multi-epoch sliding window, in accordance with an aspect of the present application. The exemplary multi-epoch sliding window in FIG. 3 may include or be associated with three active epochs and one inactive epoch. In diagram 300, several snapshots in time are depicted with each epoch presented as a specifically shaded rectangle (as in the index depicting patterns 302, 304, and 306) and the full IV increasing in an upward direction (350). Each rectangle is also depicted with the value of the MSBs (epoch-identifying bits) of the requester's IV-LSB, e.g., {00,01,10,11} in binary.

During each snapshot, the three active epochs of the sliding window are depicted with a bold dashed-line border. The sliding window, e.g., for a four-epoch system, may be associated with three active epochs and one inactive epoch. The active epochs may be depicted with no pattern fill (304), in which requests may arrive in any order with IV values from any of the three active epochs. Responder may send responses to requests in these active epochs in any order, which causes the corresponding requests to be retired or marked by the requester as no longer outstanding (e.g., by decrementing the ORC value for the given epoch). The one inactive epoch may be depicted with a diagonally right-slanting line pattern (302), in which no requests have arrived yet, because there are still some outstanding requests in the oldest active epoch. Epochs in which no arrival is possible may be depicted by a cross-hatch pattern (306), in which no arrival of requests are possible.

Furthermore, all arriving requests sent based on the IV-MSB of the requester for each set of {00,01,10,11} in bits [17:16] of the requester's epoch counter may use the same upper bits [63:18] as part of the IV-MSB. As a result, bits [63:18] remain the same through four epochs in a “cycle” N, as the requester sends requests using 2¹⁶ IVs for each of the four epochs denoted by {00,01,10,11} in bits [17:16]. When all active epochs are in the same such cycle N, all arriving requests may simply use the matching IV-MSB for that cycle along with the appropriate epoch-identifying bits (e.g., as depicted by IV_MSB_{N} 320) and may also use the same primary key K_{N} 321.

When the requester advances its full IV to a value which results in a wrap-around or carry of bits in [63:18] (i.e., moves to a next cycle N+1), some arriving requests may use the IV-MSB and key for cycle N+1 (e.g., IV-MSB_{N+1} 322 and K_{N+1}323), while other arriving requests may still use the IV-MSB and key for cycle N (e.g., IV-MSB_{N} 320 and K_{N} 321). The responder may determine the appropriate IV-MSB to use by determining a possible set of matching epoch identifiers comprising the LSBs of a current value of the partial IV or a value of a previous partial IV stored by the responder. The responder may further determine whether the two MSBs of the received IV-LSB match any of the possible set of matching epoch identifiers. If a match is found (denoting that the sliding window covers epochs in a same cycle), the responder constructs the full IV based on the partial IV with the two or more LSBs matching the two or more MSBs of the IV-LSB. If a match is not found (denoting that the sliding window covers epochs which span different cycles), the responder increments its partial IV and constructs the full IV based on the incremented partial IV.

The responder may store the incremented partial IV. In some aspects, the responder may delete the value of a previously stored partial IV corresponding to the newly inactive epoch.

19

For example, at a time 310, a sliding window 330 may be associated with three active epochs {01,10,11} in a same cycle N, which corresponds to IV-MSB_{N} 320 and K_{N} 321. The next cycle N+1 may be associated with four inactive epochs, which corresponds to IV-MSB_{N+1} 322 and K_{N+1} 323. The values of the keys at time 310 may include: the primary key with a value of K_{N} 321; the new key with a value of K_{N+1} 323; and the alternate key with a null value. During sliding window 330, the requester may encrypt and send requests, and the responder may receive and decrypt those requests, using the matching [K_{N}+IV-MSB_{N}] values (at this time, the primary key) (351).

The responder may track the current epoch counter and store the two prior epoch counters and indicators of the key used (i.e., IV-MSB_{N} including the appropriate two epoch-identifying bits and K_{N}) (352), as described above in relation to 216 and 284, respectively, in FIGS. 2B and 2D. All arriving requests use the matching IV-MSBN values with the appropriate epoch-identifying bits (352).

When the requester reaches the end of active epoch {11} (indicated by 353), the requester may pause to perform the check of whether the ORC for the oldest active epoch (here, active epoch {01}) is zero. At a time 312, the requester may resume sending requests when the check returns a result of zero (354). The requester may slide the window (depicted by a sliding window 332) by incrementing its requester EV (355). Because the advancement of the sliding window at time 312 results in a “carry” or “wraparound” of the requester's IV-MSB (with the epoch-identifying bits [17:16] as {00}), arriving requests may use either the saved matching [K_{N} 321 +IV-MSB_{N} 320] values or the current/new [K_{N+1} 323 +IV-MSB_{N+1} 322] values.

The requester may determine whether to roll or refresh the keys (as in the decisions and operations prior to operation 2009 in FIG. 2E). If the requester EV equals the KRV (356), the requester may reset its EV and perform the key roll (357), by: setting the alternate key to the value of Primary K_{N} 321; setting the primary key to the value of the new key K_{N+1} 323; and replacing the new key with, e.g., K_{N+2} 325 (as in 311 which indicates the values of the keys at time 312).

As the requester resumes sending requests at time 312, the requester may send a first request (358) encrypted based on the primary key (which now has the value K_{N+1} 323 of the previous “new” or “pending” key). The requester may store the EV and transaction number and indicator of key used (e.g., primary or alternate, here, primary).

During sliding window 332 depicted at time 312, the responder may receive an encrypted request indicating a new epoch 00 (359), and the responder may increment it responder EV (360) (as in operations 2042, 2044, 2046, and 2047 of FIG. 2G). The responder may store the two prior EVs and the indicator of the key used (361) (as in operation 2051).

The responder may determine whether to roll or refresh the keys (as in the decisions and operations prior to operation 2050 in FIG. 2G). If the responder EV equals the KRV (362), the responder resets it EV and performs the key roll (363), by: setting the alternate key to the value of Primary K_{N} 321; setting the primary key to the value of the new key K_{N+1} 323; and replacing the new key with, e.g., K_{N+2} 325 (as in 313, which indicates the values of the keys at time 312).

Thus, the responder can decrypt the first request (364) using the now primary key, specifically, [K_{N+1} 323+IV-MSB_{N+1} 322]. The responder can store the EV and indicator of the key used (e.g., primary or alternate, here, primary).

The responder may now decrypt requests received (and encrypt responses to be sent) in the newly active epoch {00} using the primary key (which now has the value K_{N+1} 323 of the previous “new” key), specifically, using the current/new [K_{N+1} 323 +IV-MSB_{N+1} 322] values (365). The responder may also continue to decrypt requests received (encrypt responses to be sent) in the prior active epochs {11,10} using the alternate key (which now has the value K_{N} 321 of the previous “primary” key), specifically, using the [K_{N} 321 +IV-MSB_{N} 320] values (365).

When the requester reaches the end of active epoch {00}, the requester may again pause sending request until the ORC for the oldest active epoch is zero, and advance the sliding window (to a sliding window 334) by incrementing the requester EV (366 at a time 314). Assume that the KRV is indicated by 353 at time 310. Since at time 314, the requester EV is not equal to the KRV (367), the requester may send a second request encrypted using the primary key (now, K_{N+1} 323) without performing the key roll (368). Thus, the key values (indicated in 315) at time 314 may be the same as the key values at 312, i.e., the key roll is not triggered at time 314.

During sliding window 334 depicted at time 314, the responder may receive the encrypted second request indicating a new epoch 01 (369), and the responder may advance the sliding window (to sliding window 334) by incrementing its responder EV (370). The responder may store the two prior EVs and the indicator of the key used (371).

As with the first request received during sliding window 332 at time 312, the responder may determine whether to roll or refresh the keys. Since the responder EV does not equal the KRV (372), the responder may decrypt the second request (373) using the now primary key, specifically, [K_{N+1} 323 +IV-MSB_{N+1} 322]. The responder may store the EV and indicator of the key used (e.g., primary or alternate, here, primary).

Similar to the responder operations for sliding window 332 at time 312, the responder may now decrypt requests received (and encrypt responses to be sent) in the newly active epoch {01} and active epoch {00} using the primary key (which has the value K_{N+1} 323), specifically, using [K_{N+1} 323 +IV-MSB_{N+1} 322] (374). The responder may also continue to decrypt requests received (and encrypt responses to be sent) in the prior active epoch {11} using the alternate key (which now has the value K_{N} 321 of the previous “primary” key), specifically, using the [K_{N} 321 +IV-MSB_{N} 320] values (374).

When the requester reaches the end of active epoch {01}, the requester may again pause sending requests until the ORC for the oldest active epoch is zero, and advance the sliding window (to a sliding window 336) by incrementing the requester EV (376 at a time 316). Recall that the KRV is indicated by 353 at time 310. Since at time 316, the requester EV is not equal to the KRV (377), the requester may send a third request encrypted using the primary key (now, K_{N+1} 323) without performing the key roll (378). Thus, the key values (indicated in 317) at time 316 may be the same as the key values at 314, i.e., the key roll is not triggered at time 314. Furthermore, at time 316, because sliding window 336 includes three active epochs which are all associated with the same N+1 cycle, only the primary key (now, K_{N+1} 323) is in use and the alternate key (K_{N}) is no longer needed. In some aspects, the requester may set the alternate key to a null value.

During sliding window 336 depicted at time 316, the responder may receive the encrypted third request indicating a new epoch {10} (379), and the responder may advance the sliding window (to sliding window 336) by incrementing its responder EV (380). The responder may store the two prior EVs and the indicator of the key used (381).

As with the first request received during sliding window 332 at time 312, the responder may determine whether to roll or refresh the keys. Since the responder EV does not equal the KRV (382), the responder may decrypt the third request (383) using the now primary key, specifically, [K_{N+1} 323 +IV-MSB_{N+1} 322]. The responder may store the EV and indicator of the key used (e.g., primary or alternate, here, primary).

Similar to the responder operations for sliding window 332 at time 312, the responder may now decrypt requests received (and encrypt responses to be sent) in all three active epochs of sliding window 332 (i.e., the newly active epoch {10} and active epochs {01,00}) using the primary key (which has the value K_{N+1} 323), specifically, using [K_{N+1} 323+IV-MSB_{N+1} 322] (384). Because sliding window 336 at time 316 no longer includes the oldest active epoch 11 (indicated at time 314), the responder will no longer use [K_{N} 321+IV-MSB_{N} 320] for its encrypted communications with the requester (384). As a result, all partial IVs associated with the prior cycle N no longer need to be stored (and may be deleted or marked to indicate free or available memory).

The new key (indicated as K_{N+2} 325 at time 312) may be refreshed by the requester or the responder at any time as part of or after the key roll at time 312 and subsequent to time 316 and before the next key roll is expected to occur (based on the KRV).

### Second Key-Rolling Technique: Multi-Epoch System With Fine-Grained State Tracking (e.g., Two-Epoch System)

FIG. 4A illustrates a bit-field chart 400 depicting a full IV 401 maintained by a requester, based on a two-epoch implementation of a multi-epoch sliding window with fine-grained state tracking, in accordance with an aspect of the present application. The requester may generate full IV 401. Full IV 401 may be generated by or based on a cipher counter (e.g., a Galois counter) and may contain a varying number of bits. For example, full IV 401 may include 96 bits, such as: static-IV fields 402 [95:64]; and a counter-generated epoch field 404 [63:11]; and a transaction number 405 [10:0]. Static-IV fields 402 may include information used by the requester, responder, or other intermediate entity, to process a message associated with full IV 401. Transaction number 405 [10:0] may also be referred to as IV-LSB 406, and requester epoch value 404 may also be referred to as IV-MSB 407 [63:11].

Epoch value 404 and transaction number 405 (i.e., IV-LSB 406) may be used to distinguish individual requests with non-sequentially numbered IV-LSBs which have been sent by the requester. Transaction number 405 [10:0] may indicate LSBs [10:0]. Epoch value 404 (i.e., bit [11]) may be referred to as the “epoch identifier” or the “epoch-identifying bit” (EIB) because that IV bit [11] may be used to unambiguously distinguish the epochs of outstanding transactions, from among the two currently active epochs (in a two-epoch system). Active epochs may be sequentially numbered, allowing epochs to be distinguished based on alternating values for the EIB (i.e., “0” indicating an odd epoch and “1” indicating an even epoch). The number of bits used for the transaction number are exemplary, and in this case, chosen to fit the 11-bit size or width of a protocol layer header field in a request message (i.e., the Protocol Tag).

FIG. 4B illustrates a bit-field chart 410 depicting a partial IV 411 maintained by a responder, based on a two-epoch implementation of a multi-epoch sliding window with fine-grained state tracking, in accordance with an aspect of the present application. The responder may maintain partial IV 411, which can include: static-IV fields 412 [95:64]; and a responder epoch value 414 [63:11]. Responder epoch value 414 may include as its LSB the epoch-identifying bit [11]. Responder epoch value 414 may also be referred to as IV-MSB 418 [63:11].

FIG. 4C illustrates a diagram 420 of hardware or data structures maintained by a requester, based on a two-epoch implementation of a multi-epoch sliding window with fine-grained state tracking, in accordance with an aspect of the present application. The requester may include in its hardware: an epoch counter 421 and a transaction number generator 422; state machine encodings 423, which may include four states per encoding in a two-epoch system; and outstanding requests counters (ORCs) 424 which track the number of requests sent by the requester which are still awaiting a response in a given epoch. ORCs 424 may include an ORC for each epoch. For example, in a two-epoch system, ORCs 424 may include: an epoch_0 ORC 425, which tracks the number of outstanding requests in an even epoch, also referred to as “N_EVEN ORC”; and an epoch_1 ORC 426, which tracks the number of outstanding requests in an odd epoch, also referred to as “N_ODD ORC.” Since, in this example, outstanding transactions at any given time may only exist in two consecutively-numbered epochs, the epoch numbers of concurrently outstanding transactions may be disambiguated by the alternating odd/even value of bit [11] of full IV 401. As such, two ORCs may be sufficient for the requester to track the counts of all outstanding transactions across two active epochs (one odd epoch and one even epoch).

The requester can pick a transaction number upon issuing a new request. If the current active epoch is ODD, the requester may pick any transaction number encoding whose state is Issuable Odd (“IssOdd”), as described below in relation to state 464 in state diagram 458 of FIG. 4E. If no such transaction number exists, and if N_EVEN_ORC is nonzero, the requester must wait; or if N_EVEN_ORC is zero, the requester may roll to the next (even) epoch, and then proceed as described below for EVEN epochs.

If the current active epoch is EVEN, the requester may pick any transaction number encoding whose state is Issuable Even (“IssEven”),, as described below in relation to state 460 in state diagram 458 of FIG. 4E. If no such transaction number exists, and N_ODD_ORC is nonzero, the requester must wait; or if N_ODD_ORC is zero, the requester may roll to the next (odd) epoch, and then proceed as described above for ODD epochs.

The requester may also include in its hardware: shared keys 427, which can include a primary key 427A, an alternate key 427B, and a new key 427C; and a key-rolling value (KRV) 428. Primary key 427A may be associated with a most recent active epoch; alternate key 427B may be associated with an oldest active epoch; and new key 427C may be associated with a currently inactive epoch. When the requester determines that a key roll is to be performed (e.g., based on the requester epoch value generated by epoch counter 421 reaching KRV 428), the system: sets the primary key to a current value of the new key; sets the alternate key to a current value of the primary key; and sets the new key to a new value.

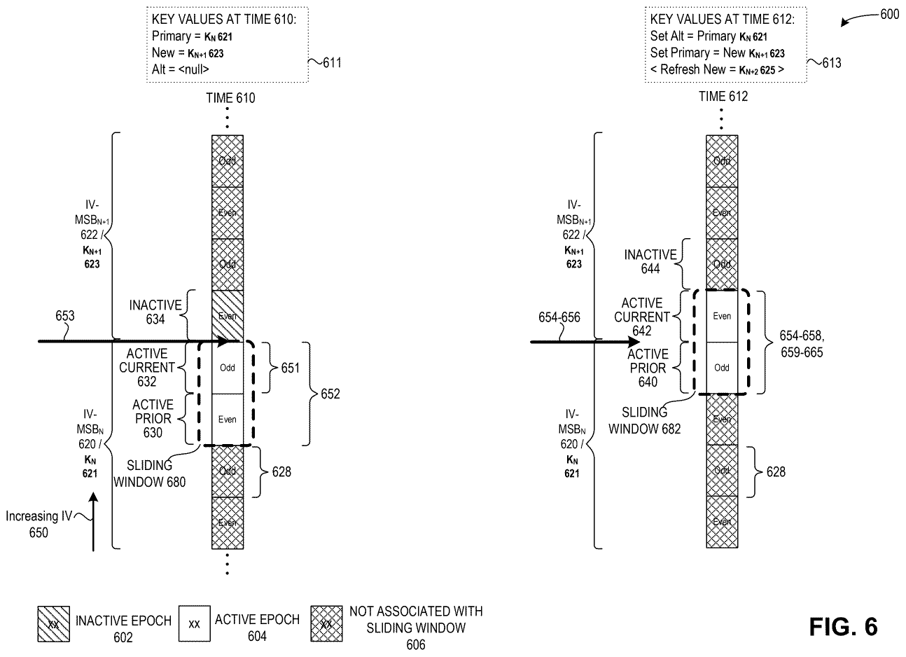

FIG. 4D illustrates a diagram 434 of hardware or data structures maintained by a responder, based on a two-epoch implementation of a multi-epoch sliding window with fine-grained state tracking, in accordance with an aspect of the present application. The responder may include in its hardware: a “current active epoch” counter 435, which can generate an epoch value corresponding to the current active epoch (e.g., indicated as bits [63:12] in FIG. 4B); the current active epoch value and an indicator of the key used 436; and a “prior active epoch” value and an indicator of the key used 437 corresponding to the prior epoch; state machine encodings 438, which may include two states per encoding in a two-epoch system; and requests received counters (RRCs) 439 which track the number of requests received by the responder in a given epoch. In this disclosure, the term “prior active epoch” may be used interchangeably with the term “oldest active epoch,” and the term “current active epoch” may be used interchangeably with “most recent active epoch.” The bit ranges describing the responder epoch value (as saved in 436 and 437 and indicated by responder epoch value 414 in the bit-field chart of FIG. 4B) may refer to bits [63:12] without the bottom 11 bits for illustrative purposes. The actual number of bits used to store the responder epoch value generated by current active epoch counter 2024 may be less than the highest numbered bit depicted for partial IV 411 (e.g., listed as 95, but maintained as 95−11=84). RRCs 439 may begin at zero, increment upon receiving a request, and reset to zero when the maximum number is reached and an “epoch roll” occurs, as described below in relation to FIGS. 4E and 6. For example, RRC reset to zero behavior may be achieved by wrapping around assuming the RRC bit width matches the IV LSB width. RRCs 439 may include an RRC for each epoch. For example, in a two-epoch system, RRCs 439 may include: an epoch_0 RRC 440, which tracks the number of requests received in an even epoch, also referred to as “M_EVEN RRC”; and an epoch_1 RRC 441, which tracks the number of requests received in an odd epoch, also referred to as “M_ODD RRC.”

The responder may also include in its hardware: shared keys 442, which can include a primary key 442A, an alternate key 442B, and a new key 442C; and a key-rolling value (KRV) 443. Similar to shared keys 427A, 427B, and 427C maintained by the requester: primary key 442A may be associated with a most recent active epoch; alternate key 442B may be associated with an oldest active epoch; and new key 442C may be associated with a currently inactive epoch. When the responder determines that a key roll is to be performed (e.g., based on the responder epoch value 414 reaching KRV 443), the system: sets the primary key to a current value of the new key; sets the alternate key to a current value of the primary key; and sets the new key to a new value. The indicator of the key used (436/437) may reference either primary key 442A or alternate key 442B.

Hence, as a result of the requester maintaining a per-encoding state and sending requests with non-sequentially updated IV values, and the responder maintaining a per-encoding state and constructing the full IV based on an association with an even or odd epoch, the described system can facilitate sliding-window based order relaxation for an encrypted channel based on an FGST multi-epoch system, e.g., by removing the requirement of in-order delivery while ensuring the necessary security (encryption/decryption).

It will be apparent to those skilled in the art that the elements illustrated in FIGS. 4C and 4D may readily be extended to cover implementations supporting a greater numbers of epochs than two, for example four, with a corresponding increase in number of instances of, e.g., outstanding request counters, received request counters, and prior epoch value stores.

FIG. 4E illustrates a diagram of a first state machine 458 with four states maintained by a requester and a second state machine 479 with two states maintained by a responder, based on a two-epoch implementation of a multi-epoch sliding window with fine-grained state tracking, in accordance with an aspect of the present application. The requester may track the state of each encoding, and the state of each encoding may be one of four possible states (e.g., based on a state machine). First state machine 458 may include four possible states for each encoding: an Issuable Even (“IssEven”) state 460 in which a request may be issued in an even epoch for the respective transaction number if there are no more outstanding requests in the prior even epoch; an Outstanding Even (“OutEven”) state 462 in which a request in the even epoch for the respective transaction number has been issued but is still awaiting a response; an Issuable Odd (“IssOdd”) state 464 in which a request may be issued in an odd epoch for the respective transaction number if there are no more outstanding requests in the prior odd epoch; or an Outstanding Odd (“OutOdd”) state 466 in which a request in the odd epoch for the respective transaction number has been issued but is still awaiting a response.

When an encoding is in IssEven state 460, the requester may send a request in an even epoch (450), which moves the encoding from IssEven state 460 to OutEven state 462. The requester may receive a response corresponding to the request sent in the even epoch (452), which moves the encoding from OutEven state 462 to IssOdd state 464. The requester may maintain a counter N_EVEN ORC 473, an up/down counter which tracks the number of requests in OutEven state 462. The requester may increment N_EVEN ORC after sending a request in the even epoch (e.g., 450), and the requester may decrement N_EVEN ORC after receiving a response to this request in the even epoch (e.g., 452). The first request of a new even epoch is allowed only when N_EVEN ORC has a value of zero. That is, as depicted by the pseudocode for the requester epoch roll and key roll logic in element 471: If there are no remaining IssOdd codes in the current epoch AND if N_EVEN ORC is equal to zero, the requester may increment its requester EV, and, if the requester EV equals the KRV, the requester may reset its requester EV to zero and perform a key roll (i.e., refreshes the keys). The free-space tracker may pick any single encoding in the issuable even state (472) (i.e., IssEven state 460) to be used in the request.

When the encoding is in IssOdd state 464, the requester may send a request in an odd epoch (454), which moves the encoding from IssOdd state 464 to OutOdd state 466. The requester may receive a response corresponding to the request sent in the odd epoch (456), which moves the encoding from OutOdd state 466 to IssEven state 460. The requester may maintain a counter N_ODD ORC 476, an up/down counter which tracks the number of requests in OutOdd state 466. The requester may increment N_ODD ORC after sending a request in the odd epoch (e.g., 454), and the requester may decrement N_ODD ORC after receiving a response to this request in the odd epoch (e.g., 456). The first request of a new odd epoch is allowed only when N_ODD ORC has a value of zero. That is, as depicted by the pseudocode for the requester epoch roll and key roll logic in element 474: If there are no remaining IssEven codes in the current epoch AND if N_ODD ORC is equal to zero, the requester may increment its requester EV, and, if the requester EV equals the KRV, the requester may reset its requester EV to zero and perform a key roll (i.e., refresh the keys). The free-space tracker may pick any single encoding in the issuable odd state (475) (i.e., IssOdd state 464) to be used in the request.

The responder may track the state of each encoding and the state of each encoding may be one of two possible states (e.g., based on a state machine). Second state machine 479 may include two possible states for each encoding: Expect Even (“ExpEven”) state 480; and Expect Odd (“ExpOdd”) state 482. The state of an encoding tracked by the responder may begin in ExpEven state 480. The responder may receive a request for an encoding in an even epoch (484), which moves the encoding from ExpEven state 480 to ExpOdd state 482. The responder may maintain a counter M_EVEN RRC 491, a resettable counter which tracks the number of requests received in an even epoch. The responder may increment M_EVEN RRC after receiving a request in the even epoch as determined by the state of the encoding in the state machine. As depicted by the pseudocode for the responder epoch roll and key roll logic in element 492: If the responder expects even and receives odd AND if M_ODD RRC is equal to the predetermined maximum number (e.g., 2¹¹), the responder may reset M_ODD RCC to zero and increment the responder epoch value (i.e., roll the epoch), and, if the responder epoch value equals the KRV, the responder may reset its responder EV to zero and perform a key roll. The reset to zero behavior for M_ODD RRC may be achieved by counter wrap-around, if the RRC counter width matches IV-LSB width.

The responder may receive a request for the same encoding in an odd epoch (486), which moves the encoding from ExpOdd state 482 to ExpEven state 480. The responder may maintain a counter M_ODD RRC 493, a resettable counter which tracks the number of requests received in an odd epoch. The responder may increment M_ODD RRC after receiving a request in the odd epoch as determined by the state of the encoding in the state machine.

As depicted by the pseudocode for the responder epoch roll and key roll logic in element 494: If the responder expects odd and receives even AND if M_EVEN RRC is equal to the predetermined maximum number (e.g., 2¹¹), the responder may reset M_EVEN RCC to zero and increment the responder epoch value (i.e., roll the epoch), and, if the responder epoch value equals the KRV, the responder may reset its responder EV to zero and perform a key roll. The reset to zero behavior for M_EVEN RRC may be achieved by counter wrap-around, if the RRC counter width matches IV-LSB width.

It will be apparent to those skilled in the art that the elements illustrated in FIG. 4E may readily be extended to describe implementations supporting a greater numbers of epochs than two (e.g., four), with a corresponding increase in number of states in cases where state names are correlated with epochs.

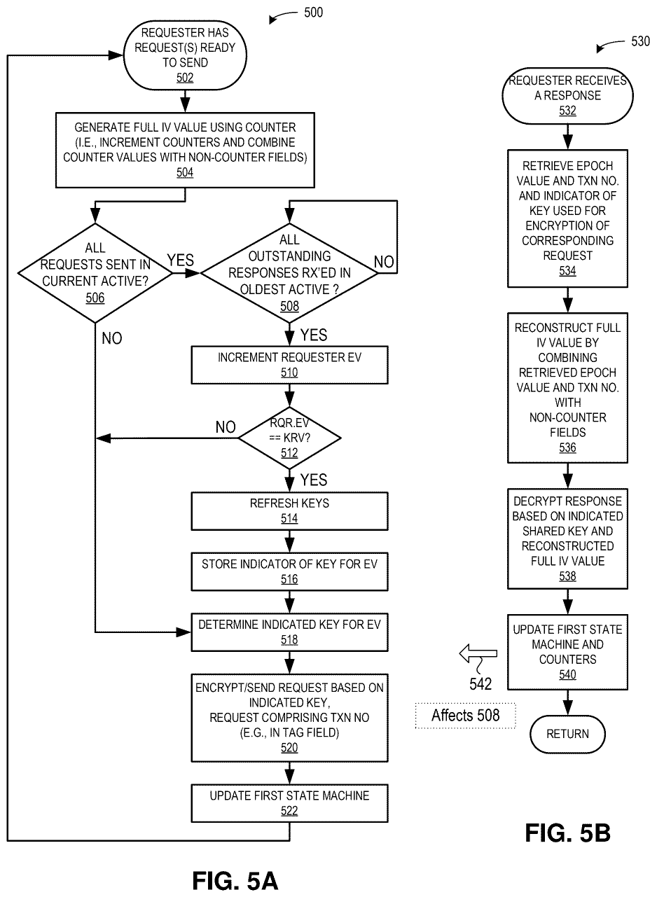

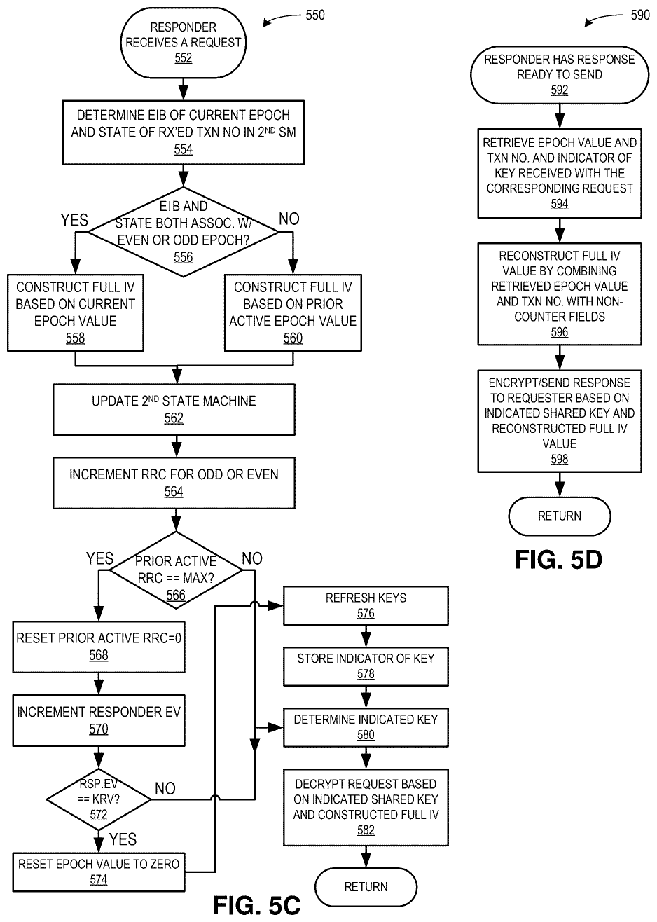

FIG. 5A presents a flowchart 500 illustrating operations by a requester in sending requests, based on a two-epoch implementation of a multi-epoch sliding window with fine-grained state tracking, in accordance with an aspect of the present application. The requester may maintain a first state machine, as described above in relation to diagram 458 in FIG. 4E. The operations by the requester may begin when the requester has a request (or requests) to send (502). The requester generates the full IV value using the counter (operation 504). That is, the requester increments counters and combines the counter values with the non-counter fields, as described above in relation to FIG. 4A and full IV 401 comprising non-counter fields 402 and counter fields 404. The MSBs (i.e., the requester epoch value) may be incremented sequentially, while the LSBs (i.e., the transaction number) may be updated non-sequentially.

The requester determines whether all requests have been sent in the current active epoch (decision 506). If all requests have not been sent in the current active epoch (decision 506), the operation continues at operation 518. If all requests have been sent in the current active epoch (decision 506), the requester determines whether all outstanding responses have been received in the oldest active epoch (decision 508). If all outstanding responses have not been received in the oldest active epoch (decision 508), the operation returns to decision 508 and waits for responses which update the first state machine and the relevant counters (e.g., N_EVEN ORC or N_ODD ORC). The conditions triggered by decisions 506 and 508 may be referred to as the two “requester conditions” for advancing the sliding window or incrementing the requester epoch value. If all outstanding responses have been received in the oldest active epoch (decision 508), the requester increments its requester EV (operation 510).

The requester determines whether the requester EV (“Rqr.EV”) is equal to the key-rolling value (KRV) (decision 512). If the requester EV is equal to the KRV (decision 512): the requester resets its EV to zero (not depicted); refreshes the keys (operation 514) (i.e., performs a key roll); and stores the indicator of the key used for the EV (operation 516). The operation continues at operation 518. As described above in relation to shared keys 427 of FIG. 4C, refreshing the keys or performing the key roll may include: setting the primary key to a current value of the new key; setting the alternate key to a current value of the primary key; and setting the new key to a new value.

If the requester EV is not equal to the KRV (decision 512), the system determines the indicated key for the EV (operation 518), based on previously stored information 436/437 of FIG. 4D. The requester encrypts and sends a request based on the indicated key, the request comprising the transaction number (e.g., in the Tag protocol field) (operation 520). The requester updates its first state machine (operation 522), as described above in relation to FIG. 4E. Flowchart 500 is depicted as a loop because individual iterations are not independent, i.e., when the requester blocks the sending of additional requests at decision 508, both current request sending and all future request sending is blocked.

FIG. 5B presents a flowchart 530 illustrating operations by a requester in receiving a response, based on a two-epoch implementation of a multi-epoch sliding window with fine-grained state tracking, in accordance with an aspect of the present application. Responses for outstanding transactions may be received in any order, independent of the order in which the corresponding requests were sent. The operations by the requester may begin when the requester receives a response (532). The requester retrieves the epoch value and transaction number and indicator of the key used for encryption of the corresponding request (operation 534). The requester reconstructs the full IV value by combining the retrieved epoch value and transaction number with the non-counter fields (operation 536). For example, the requester may retrieve a previously stored epoch value and transaction number for the request corresponding to the received response and may use non-counter fields 202 to reconstruct the full IV.

The requester decrypts the response based on the indicated shared key and the reconstructed full IV (operation 538), and the requester updates the first state machine and counters (operation 540). For example, the requester may decrement the ORC corresponding to the epoch retrieved epoch value (as described above in relation to ORCs 424 in FIG. 4C). If the response happens to match the final outstanding transaction in the oldest active epoch, then the action of decrementing the ORC for the appropriate epoch to zero may end a pause or blocking performed by the requester as part of decision 508 (as indicated by 542). Flowchart 530 is depicted as a linear flow rather than a loop (as in flowchart 500) because each received response may have an independent flow. In contrast to sending requests, sequential dependency does not exist between received responses.

FIG. 5C presents a flowchart 550 illustrating operations by a responder in receiving a request, based on a two-epoch implementation of a multi-epoch sliding window with fine-grained state tracking, in accordance with an aspect of the present application. The responder may maintain a second state machine, as described above in relation to diagram 479 in FIG. 4E. The operations by the responder may begin when the responder receives a request (552). Requests may be received by the responder in a different order versus the order they were sent by the requester. The request may be encrypted based on a shared key and a full IV, and the request may include the IV-LSB as the transaction number in the Tag protocol field. The responder determines the EIB of the current epoch and the state of the received IV-LSB (i.e., transaction number) in the second state machine (operation 554) and then determines whether the EIB and the state are both associated with an even or an odd epoch (decision 556).

If the EIB and the received IV-LSB state are both associated with an even or an odd epoch (decision 556) (denoted as [EIB, IV-LSB.state]==[even,even] or [EIB, IV-LSB.state]==[odd,odd]), the responder constructs the full IV based on the current epoch value and the received transaction number (operation 558). If the EIB and the received IV-LSB state are not both associated with an even or an odd epoch (decision 556) (denoted as [EIB, IV-LSB.state]==[odd,even] or [EIB, IV-LSB.state]==[even,odd]), the responder constructs the full IV based on the prior active epoch value and the received transaction number (operation 560). For example, the responder may combine its responder epoch value 414 (and the received transaction number (IV-LSB 406) to construct the full IV. The full IV may include the partial IV as its MSBs and the received transaction number as its LSBs.

The responder updates the second state machine (operation 562), e.g., sets the state to ExpectOdd or ExpectEven, as described above in relation to FIG. 4E. The responder increments the appropriate counter (e.g., M_EVEN RRC or M_ODD RRC) (operation 564). If the prior active RRC is not equal to the maximum value, the operation continues at operation 580. If the prior active RRC is equal to the maximum value (decision 566), the responder resets the prior active RRC to zero (operation 568) and increments the responder EV (operation 570). The conditions triggered by decisions 556 and 566 may be referred to as the two “responder conditions” for advancing the sliding window or incrementing the responder epoch value.

The responder determines whether the responder EV (“Rsp.EV”) is equal to the key-rolling value (KRV) (decision 572). If the responder EV Is not equal to the KRV (decision 572), the operation continues at operation 580. If the responder EV is equal to the KRV (decision 572), the responder resets its responder EV to zero (operation 574) and refreshes the keys (operation 576), similar to the key roll operation performed by the requester in operation 514 of FIG. 5A. For example, as described above in relation to shared keys 442 of FIG. 4D, refreshing the key or performing the key roll may include: setting the primary key to a current value of the new key; setting the alternate key to a current value of the primary key; and setting the new key to a new value.

The responder stores the indicator of the key for the EV (operation 578), the key to be used in decrypting the current request and for subsequent use when generating a response to the request, as described below in relation to FIG. 6. When the responder is ready to decrypt the request, the responder determines the indicated key (operation 580) and decrypts the request based on the indicated shared key and the constructed full IV (operation 582). The operation returns. Flowchart 550 is depicted as a linear flow rather than a loop (as in flowchart 500) because there are neither sequential dependencies nor implied orderings between distinct transactions, or between request order and response order.

FIG. 5D presents a flowchart 590 illustrating operations by a responder in sending a response, based on a two-epoch implementation of a multi-epoch sliding window with fine-grained state tracking, in accordance with an aspect of the present application. Responses may be sent by the responder in a different order versus the order the corresponding requests were received. The operations by the responder may begin when the responder has a response ready to send to the requester (592). The responder retrieves the epoch value and transaction number received and indicator of the key used with the corresponding request (operation 594), e.g., as previously stored in 436/437 in FIG. 4D as part of operation 578. The responder reconstructs the full IV by combining the retrieved epoch value and transaction number with the non-counter fields (operation 596). For example, the responder may retrieve the previously stored epoch value and transaction number for the response from 437 in FIG. 4D. The responder may also use static-IV fields 412 (as depicted in partial IV 411 in FIG. 4B) to reconstruct the full IV.

The responder encrypts and sends to the requester the response based on the indicated shared key and the reconstructed full IV value (operation 598). The responder does not include the IV-LSB in the response. The operation returns. Flowchart 590 is depicted as a linear flow rather than a loop (as in flowchart 500) because there are neither sequential dependencies nor implied orderings between distinct transactions, or between request order and response order.

FIG. 6 illustrates a diagram 600 of operations, including key-rolling operations, by a requester and a responder, based on a two-epoch implementation of a multi-epoch sliding window with fine-grained state tracking, in accordance with an aspect of the present application. In diagram 600, two snapshots in time 610 and 612 are depicted with each epoch presented as a specifically shaded rectangle (as in the index depicting patterns 602, 604, and 606) and the full IV increasing in an upward direction (650). Each rectangle is also depicted with the value of the LSB of the requester epoch value (also referred to as the epoch-identifying bit). This epoch-identifying bit (EIB) may indicate whether the epoch is an even epoch (with a value of 0) or an odd epoch (with a value of 1).

During each snapshot, the active epochs of the sliding window are depicted with a bold dashed-line border. In a two-epoch system, the sliding window may include or be associated with two active epochs (one even epoch and one odd epoch). The active epochs may be depicted with no pattern fill (604), in which the requester may send requests with the maximum number of IV values in any order based on the state for each IV-LSB encoding. An inactive epoch may be depicted with a diagonally right-slanting line pattern (602), which represents the next epoch which will become current following the next epoch roll operation. Inactive prior epochs may be depicted by a cross-hatch pattern (606).

At time 610, a sliding window 680 may be associated with two active epochs in a same cycle N, which corresponds to IV-MSB_{N} 620 and K_{N} 621. The next cycle N+1 may be associated with a number of inactive epochs, which corresponds to IV-MSB_{N+1} 622 and K_{N+1} 623. The values of the keys (indicated in 611) at time 610 may include: the primary key with a value of K_{N} 621; the new key with a value of K_{N+1} 623; and the alternate key with a null value.

For each active epoch in sliding window 680, the requester may send requests with the maximum number of IV values in any order, e.g., by using a free-space tracker. At time 610, the requester may have previously rolled to active current (odd) epoch 632 if two “requester conditions” are satisfied (651): 1) requests were issued for all IV values in the current epoch (at that time, 630); and 2) responses were received for all outstanding requests in the prior epoch (at that time, 628).

During sliding window 680 (which includes epochs 630 and 632) at time 610, the requester may encrypt and send requests, and the responder may receive and decrypt those requests, using the matching [K_{N}+IV-MSB_{N}] values (at this time, the primary key) (652). The requester and the responder may both update their respective state machines. The requester may determine if the two requester conditions are triggered or satisfied (653), i.e.: 1) requests were issued for all IV values in the active current epoch 632; and 2) responses have been received for all outstanding requests in the active prior epoch 630. If the two conditions are satisfied, the requester slides the window (depicted by a sliding window 682) by incrementing its requester EV (654).

The requester may determine whether to roll or refresh the keys (as in the decisions and operations prior to operation 514 in FIG. 5A). Assume that the KRV is indicated by 653 at time 610. Since the requester EV equals the KRV (655), the requester may reset its EV and perform the key roll (656), by: setting the alternate key to the value of Primary K_{N} 621; setting the primary key to the value of the new key K_{N+1} 623; and replacing the new key with, e.g., K_{N+2} 625 (as in 613, which indicates the values of the keys at time 612). The triggering conditions for performing the requester epoch roll and the key roll are described above in relation to elements 471 and 474 of state diagram 458 in FIG. 4E.

Thus, at time 612, the requester encrypts and sends requests using the primary key K_{N+1} 623 in the active current epoch 642 (657) and also continues to encrypt and send requests using the alternate key K_{N} 621 in active prior epoch 640 (658).

Based on the updates to the second state machine by the responder, the responder may also perform an epoch roll and a key roll. For example, the responder may determine if two “responder conditions” are triggered or satisfied (659), i.e.: 1) the responder expects odd and receives even; and 2) M_EVEN RRC is equal to the maximum value. If the two responder conditions are satisfied, the responder resets M_EVEN RRC to zero and slides the window (depicted by sliding window 682) by incrementing its responder EV (660).

The responder may determine whether to roll or refresh the keys (as in the decisions and operations prior to operation 576 in FIG. 5C). Assume that the KRV is indicated by 653 at time 610. Since the responder EV equals the KRV (661), the responder may reset its EV and perform the key roll (662), by: setting the alternate key to the value of Primary K_{N} 621; setting the primary key to the value of the new key K_{N+1} 623; and replacing the new key with, e.g., K_{N+2} 625 (as in 613, which indicates the values of the keys at time 612). The triggering conditions for performing the responder epoch roll and the key roll are described above in relation to elements 492 and 494 of state diagram 479 in FIG. 4E.

Thus, at time 612, the requester continues to encrypt and send requests in both active current epoch 642 and active prior epoch 640, using both keys (depending on the corresponding epoch value), i.e., the primary key K_{N+1} 623 in 642 and the alternate key K_{N} 621 in 640 (663). The responder receives and decrypts requests, and also encrypts and sends the corresponding responses, also using both keys (depending on the epoch value), i.e., the primary key K_{N+1} 623 in 642 and the alternate key K_{N} 621 in 640 (664). In addition, the requester receives and decrypts the responses in both active current epoch 642 and active prior epoch 640, using both keys (depending on the epoch value), i.e., the primary key K_{N+1} 623 in 642 and the alternate key K_{N} 621 in 640 (665).

It will be apparent to those skilled in the art that the elements illustrated in FIG. 6 may readily be extended to describe implementations supporting a greater numbers of epochs than two (e.g., four), with a corresponding increase in the number of active epochs within the sliding windows.

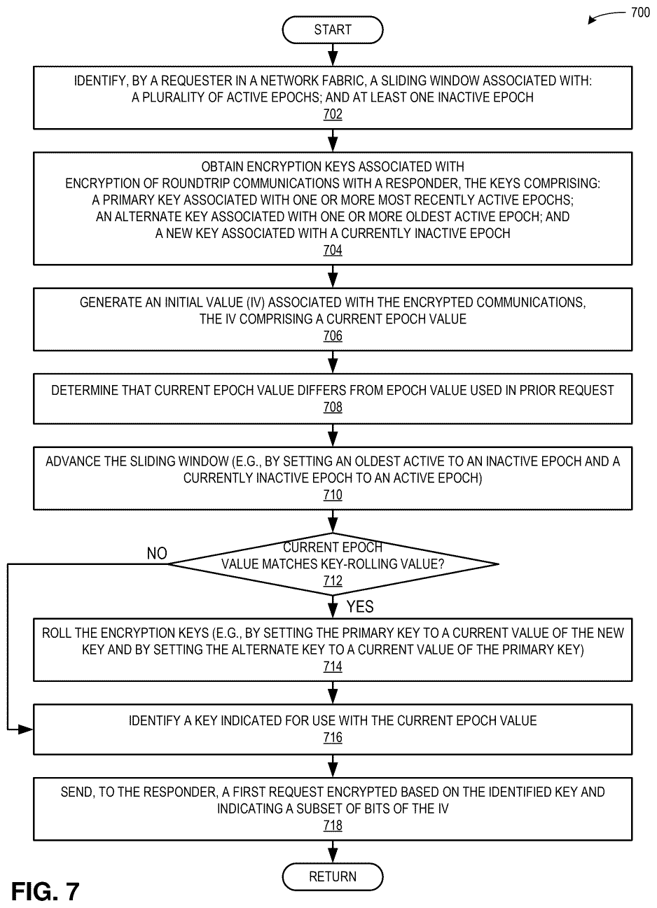

FIG. 7 presents a flowchart 700 illustrating a key-rolling method for sliding-window based order relaxation, in accordance with an aspect of the present application. The system identifies, by a requester in a network fabric, a sliding window associated with: a plurality of active epochs corresponding to a time window in which a predetermined number of requests are allowed to be sent; and at least one inactive epoch corresponding to a time window in which requests are not allowed to be sent (operation 702). For example, in FIG. 3 at time 310, the requester may identify three active epochs {00,01,10} and one inactive epoch {11}, where the active epochs and the inactive epoch are depicted based on specific shadings or fill patterns (as described above in relation to 302, 304, and 306 of FIG. 3).

The system obtains, by the requester, encryption keys associated with encryption of roundtrip communications with a responder (operation 704). The requester and the responder may each maintain or obtain a same set of keys, based on cryptographic mechanisms known in the art, including but not limited to, e.g.: asymmetric key exchange algorithms; pre-shared symmetric keys using secure out-of-band distribution, a key management system, a hardware security module, or a trusted third party; and public key certificates. The requester and the responder may each store the same set of keys in hardware or a data structure, as described above in relation to, respectively, FIGS. 2C/4C and 2D/4D. The shared encryption keys may include: a primary key associated with a most recent active epoch; an alternate key associated with an oldest active epoch; and a new key associated with a currently inactive epoch.

The system generates, by the requester, an initial value (IV) associated with the encrypted communications, the IV comprising a current epoch value (operation 706). For example, a requester may generate a cipher counter (such as a Galois counter), also referred to as full IV 201 which includes both non-counter field 202 and counter fields 204. The initial value of the full IV may be a value agreed-upon by the requester and the responder, e.g., all zeros, a number that fits within the width of a number of bits comprising the full IV, or some other predetermined number. The requester may maintain the full IV and the responder may maintain a partial IV, as described above in relation to FIGS. 2B/4B.

The system determines that the current epoch value differs from an epoch value used in a prior (i.e., previously sent) request (operation 708). For example, as described above in relation to decision 2006 in FIG. 2E, the requester may determine whether its requester epoch value indicates that a new epoch is in use, which may be indicated by a change in the requester epoch value resulting from a carry from the transaction number field during the increment operation 2004.

The requester advances the sliding window (operation 710), e.g., by setting an oldest active epoch to an inactive epoch and a currently inactive epoch to an active epoch advancing the sliding window. In FIG. 3 (as depicted prior to advancing the sliding window at time 310), the requester may advance sliding window 330 by setting oldest active epoch {01} to an inactive epoch and by setting currently inactive epoch {00} to an active epoch, resulting in sliding window 332 (as depicted subsequent to advancing the sliding window at time 312).

The system determines, by the requester, whether the current epoch value matches a predetermined key-rolling value (KRV) (decision 712). For example, the requester may compare its current epoch value (273 in FIG. 2C) with the KRV (278 in FIG. 2C) agreed upon by the requester and the responder.

If the current epoch value does not match the KRV (decision 712), the operation continues at operation 716. If the current epoch value does match the KRV (decision 712), the system, by the requester, rolls the encryption keys (operation 714), e.g., by setting the primary key to a current value of the new key and by setting the alternate key to a current value of the primary key.

The system identifies or obtains a key indicated for use with the current epoch value (operation 716). For example, the requester may obtain, from the requester hardware or maintained data structure, a key associated with current epoch value 273 and indicated in counter fields and key indicator 275 of FIG. 2C.

The system sends, to the responder, a first request encrypted based on the identified key (associated with the current epoch value) and indicating a subset of bits of the IV (operation 718). For example, based on a request that the requester is ready to send (as in operation 2002 of FIG. 2E), the requester may encrypt the request based on the full IV and the shared primary key (as in operation 2008 of FIG. 2E), and the requester may send the encrypted request indicating the IV-LSB (i.e., the subset of bits of the IV) to the responder (as in operation 2012 of FIG. 2C). The IV-LSB may be transmitted in cleartext or as part of a protocol Tag header or other unencrypted header field. The operation returns.

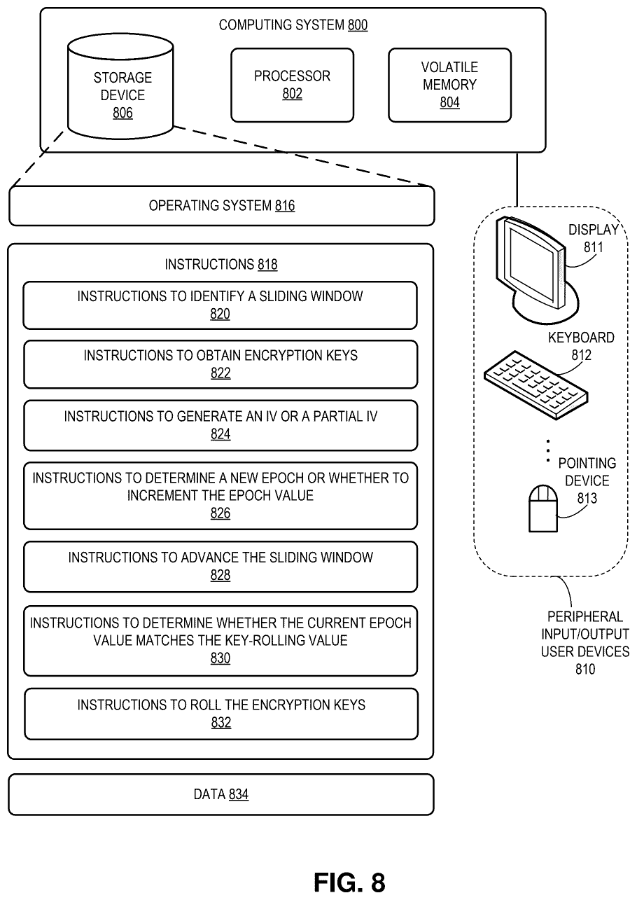

FIG. 8 illustrates a computing system which facilitates a key-rolling method for sliding-window based order relaxation, in accordance with an aspect of the present application. Computing system 800 includes at least one processor 802, a memory 804, and a storage device 806. Memory 804 may include a volatile memory (e.g., random access memory (RAM)) that serves as a managed memory and can be used to store one or more memory pools. Furthermore, computing system 800 may be coupled to peripheral I/O user devices 810 (e.g., a display device 811, a keyboard 812, and a pointing device 813). Storage device 806 includes non-transitory computer-readable storage medium and stores an operating system 816, instructions 818, and data 834. Computing system 800 may include fewer or more entities or instructions than those shown in FIG. 8.

Instructions 818, when executed by the at least one processor 802 can cause the at least one processor and computing system 800 to perform methods and/or processes described in this disclosure. Instructions 818 may include instructions performed by a requester (or by requester functionality in computing system 800) or by a responder (or by responder functionality in computing system 800). Specifically, instructions 818 may include instructions 820 to identify a sliding window associated with: a plurality of active epochs corresponding to a time window in which a predetermined number of requests are allowed to be sent; and at least one inactive epoch corresponding to a time window in which requests are not allowed to be sent. Identifying a sliding window by the requester is described in relation to operation 2004 in FIG. 2E, operations 504-510 in FIG. 5A, sliding windows in FIGS. 3 and 6, and operation 702 of FIG. 7. Identifying a sliding window by the responder is described in relation to FIGS. 3 and 6.

Instructions 818 may further include instructions 822 to obtain encryption keys associated with encryption of roundtrip communications with a responder. Obtaining the encryption keys described above in relation to: by the requester, 271 in FIGS. 2C, 427 in FIG. 4C, and operation 704 of FIG. 7; and by the responder, 281 in FIGS. 2D and 442 in FIG. 4B.

Instructions 818 may include instructions 824 to generate an initial value (IV) associated with the encryption of the roundtrip communications, the IV comprising a current epoch value, or a partial IV, as described above in relation to: by the requester, operation 2004 in FIG. 2E and operation 706 in FIG. 7; and by the responder, 211 in FIGS. 2B and 411 in FIG. 4B.

Instructions 818 may include instructions 826 to determine a new epoch or whether to increment the epoch value, as described above in relation to: by the requester, operation 2016 in FIG. 2E and operation 708 ion FIG. 7; and by the responder, operations 2044-2048 in FIG. 2G and operations 556, 566, and 570 in FIG. 5C. Instructions 818 may also include instructions 828 to advance the sliding window, as described above in relation to: by the requester, FIGS. 3 and 6, and operation 710 of FIG. 7; and by the responder, FIGS. 3 and 6.

Instructions 818 may include instructions 830 to determine whether the current epoch value matches the key-rolling value, as described above in relation to: by the requester, operations 2015-2019 in FIG. 2E and operations 712 and 714 in FIG. 7; and by the responder, operations 2041, 2043, and 2045 in FIG. 2G and operations 572-576 in FIG. 5C.

Instructions 818 may include instructions 832 to roll the encryption keys, as described above in relation to: by the requester, operations 2015-2019 in FIG. 2E and operations 712 and 714 in FIG. 7; and by the responder, operations 2041, 2043, and 2045 in FIG. 2G and operations 572-576 in FIG. 5C.

Instructions 818 may also include instructions which facilitate the transmission of encrypted roundtrip communications (e.g., requests and responses) between the requester and the responder. For example, instructions 818 may include instructions (not shown in FIG. 8) to send, to the responder, a first request encrypted based on an obtained key associated with the current epoch value and indicating a subset of bits of the IV, as described above in relation to operation 2012 in FIG. 2E and operations 716 and 718 in FIG. 7.

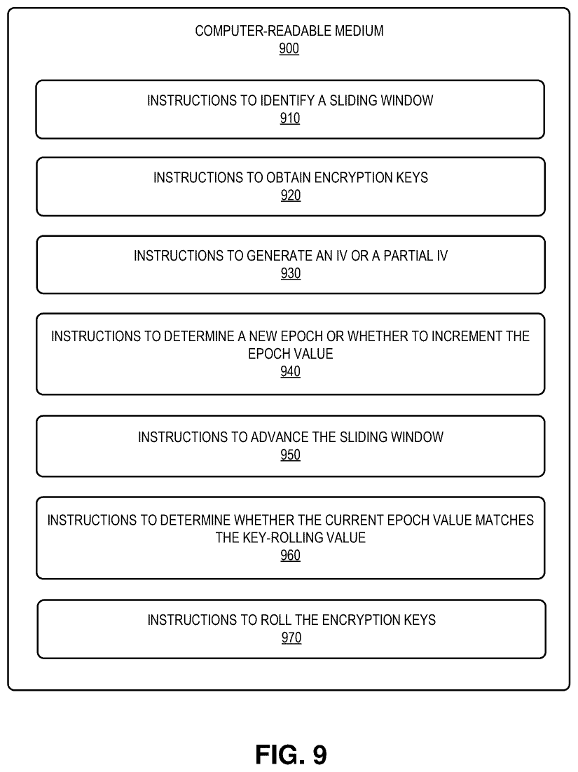

Instructions 818 may include more instructions than those shown in FIG. 8. For example, instructions 818 may include instructions for executing the operations described above in relation to: the flowcharts of FIGS. 2E-H and 5A-D; the sliding windows of FIGS. 3 and 6; the state diagram of FIG. 4E; the operations in FIG. 7; and the instructions of CRM 900 in FIG. 9.

Data 834 can include any data that is required as input or that is generated as output by the methods, operations, communications, and/or processes described in this disclosure. Specifically, data 834 can store at least: a request; a security value; a sequentially ordered security value; a response; an initial value (IV); a counter value; a full IV; a constructed full IV; an incremented IV value; a partial IV; a current or previous partial IV value; one or more MSBs or LSBs; a predetermined number; a key-rolling value; an identifier or indicator of an epoch corresponding to a time window in which a certain number of requests may be sent; an indicator of an active or inactive epoch; an encrypted request or response; a shared key; a primary key; an alternate key; a new key; an epoch-identifier; epoch-identifying bits; a set of matching epoch-identifiers; non-counter fields; counter fields; an IV-MSB; an IV-LSB; an epoch counter; an epoch counter value; an epoch number; a transaction number; a number of outstanding responses; an outstanding requests counter value; a number of requests sent in an epoch; an outstanding responses counter value; and a number of corresponding responses received in an epoch.

FIG. 9 illustrates a computer-readable medium (CRM) 900 which facilitates sliding-window based order relaxation for an encrypted channel, in accordance with an aspect of the present application. CRM 900 can be a non-transitory computer-readable medium or device storing instructions that when executed by a computer or processor cause the computer or processor to execute the instructions or perform a method. CRM 900 may store instructions 910 to identify a sliding window associated with: a plurality of active epochs corresponding to a time window in which a predetermined number of requests are allowed to be sent; and at least one inactive epoch corresponding to a time window in which requests are not allowed to be sent. Identifying a sliding window by the requester is described in relation to operation 2004 in FIG. 2E, operations 504-510 in FIG. 5A, sliding windows in FIGS. 3 and 6, and operation 702 of FIG. 7. Identifying a sliding window by the responder is described in relation to FIGS. 3 and 6.

CRM 900 may store instructions 920 to obtain encryption keys associated with encryption of roundtrip communications with a responder. Obtaining the encryption keys described above in relation to: by the requester, 271 in FIGS. 2C, 427 in FIG. 4C, and operation 704 of FIG. 7; and by the responder, 281 in FIGS. 2D and 442 in FIG. 4B.

CRM 900 may store instructions 930 to generate an initial value (IV) associated with the encryption of the roundtrip communications, the IV comprising a current epoch value, or a partial IV, as described above in relation to: by the requester, operation 2004 in FIG. 2E and operation 706 in FIG. 7; and by the responder, 211 in FIGS. 2B and 411 in FIG. 4B.

CRM 900 may store instructions 940 to determine a new epoch or whether to increment the epoch value, as described above in relation to: by the requester, operation 2016 in FIG. 2E and operation 708 ion FIG. 7; and by the responder, operations 2044-2048 in FIG. 2G and operations 556, 566, and 570 in FIG. 5C.

CRM 900 may store instructions 950 to advance the sliding window, as described above in relation to: by the requester, FIGS. 3 and 6, and operation 710 of FIG. 7; and by the responder, FIGS. 3 and 6.

CRM 900 may store instructions 960 to determine whether the current epoch value matches the key-rolling value, as described above in relation to: by the requester, operations 2015-2019 in FIG. 2E and operations 712 and 714 in FIG. 7; and by the responder, operations 2041, 2043, and 2045 in FIG. 2G and operations 572-576 in FIG. 5C. CRM 900 may store instructions 970 to roll the encryption keys, as described above in relation to: by the requester, operations 2015-2019 in FIG. 2E and operations 712 and 714 in FIG. 7; and by the responder, operations 2041, 2043, and 2045 in FIG. 2G and operations 572-576 in FIG. 5C.

CRM 900 may store instructions which facilitate the transmission of encrypted roundtrip communications (e.g., requests and responses) between the requester and the responder. For example, CRM 900 may store instructions (not shown in FIG. 8) to send, to the responder, a first request encrypted based on an obtained key associated with the current epoch value and indicating a subset of bits of the IV, as described above in relation to operation 2012 in FIG. 2E and operations 716 and 718 in FIG. 7.

CRM 900 may include more instructions than those shown in FIG. 9. For example, CRM 900 may also store instructions for executing the operations described above in relation to: the flowcharts of FIGS. 2E-H and 5A-D; the sliding windows of FIGS. 3 and 6; the state diagram of FIG. 4E; the operations in FIG. 7; and the instructions of computing system 800 in FIG. 8.

The term “network device” refers to any device, component, or computing entity which can provide a communication pipeline for packets sent from a “processing node” or an “endpoint node.” An example of a network device may be a switch, as described above in relation to FIG. 1. A processing or endpoint node may refer to a device, component, or hardware component which can operate as a source or a destination of data, including e.g., a control packet or a data packet. A processing node or endpoint node may be referred to as a “requester” or a “responder.” A requester and a responder may transmit data (e.g., a request or a response) to each other over the communication pipeline as a roundtrip communication. The requester may generate and send an encrypted request to the responder. The responder may decrypt the request, generate a response, and send an encrypted response back to the requester. The requester may subsequently decrypt the response. Accordingly, the requester and the responder may each be an endpoint for data sent across the communication pipeline (e.g., a network fabric such as fabric 110 in FIG. 1). Additionally, an endpoint node or processing node may serve as both a requester and a responder. That is, an endpoint or processing node may include both requester functionality and responder functionality, as described herein, including at, e.g., FIG. 4 describing the operations and communications of a requester and a responder with respect to the IV-MSB 410 and IV-LSB 430.

In general, the disclosed aspects provide a method, a computing system, and a computer-readable medium which facilitate a key-rolling method for sliding-window based order relaxation. In one aspect, the system identifies, by a requester in a network fabric, a sliding window associated with: a plurality of active epochs corresponding to a time window in which a predetermined number of requests are allowed to be sent; and at least one inactive epoch corresponding to a time window in which requests are not allowed to be sent. The system obtains encryption keys associated with encryption of roundtrip communications with a responder. The system generates an initial value (IV) associated with the encryption of the roundtrip communications, the IV comprising a current epoch value. The system determines that the current epoch value differs from an epoch value used in a previously sent request. The system advances the sliding window. Responsive to the current epoch value matching a predetermined key-rolling value, the system rolls the encryption keys. The system sends, to the responder, a first request encrypted based on an obtained key associated with the current epoch value and indicating a subset of bits of the IV.

In a variation on this aspect, the encryption keys comprise: a primary key associated with a most recent active epoch; an alternate key associated with an oldest active epoch; and a new key associated with a currently inactive epoch. Rolling the encryption keys comprises: setting the primary key to a current value of the new key; setting the alternate key to a current value of the primary key; and setting the new key to a new value.

In a further variation, the predetermined key-rolling value is based on at least one of: a value agreed upon by the requester and the responder; or messages exchanged between the requester and the responder.

In a further variation, responsive to the current epoch value matching the predetermined key-rolling value, the system resets the current epoch value to zero.

In a further variation, the IV comprises: most significant bits (MSBs) indicating an epoch value to be incremented by the requester or the responder; and least significant bits (LSBs) indicating a transaction number.

In a further variation, the system sends encrypted requests to the responder and decrypts corresponding received responses from the responder, by the requester, in a same epoch corresponding to the current epoch value based on an obtained key associated with the current epoch.

In a further variation, the system maintains, by the responder, a partial IV comprising a responder epoch value based on most significant bits of the IV. The obtains, by the responder, the same keys obtained by the requester. The system receives, by the responder, the first encrypted request from the requester, wherein the indicated subset of bits comprises a transaction number. The system determines, by the responder, whether to increment the responder epoch value based on one or more of: one or more bits of the partial IV; the transaction number; the current responder epoch value; a state associated with the transaction number; and a number of requests outstanding in a prior active epoch. Responsive to incrementing the responder epoch value, the system: advances the sliding window; and responsive to the current responder epoch value matching the predetermined key-rolling value, rolls the encryption keys, by the responder.

In a further variation, the system decrypts, by the responder, the first encrypted request from the requester, based on an obtained key associated with an epoch corresponding to the current responder epoch value. The system encrypts a corresponding response to the requester based on the obtained key.

In a further variation, the system maintains, by the requester, a first state machine for each transaction number in a respective epoch, the first state machine tracking request issuance and response status for a respective transaction number across multiple epochs. The system increments, by the requester, the current epoch value based on: sending the predetermined number of requests for a most recent active epoch; and determining that outstanding responses have been received for all requests sent for an oldest active epoch.

In a further variation, the system maintains, by the responder, a second state machine for each transaction number in an epoch, the second state machine indicating two states based on whether a request is expected to be received by the responder in an even epoch or an odd epoch. The system updates, by the responder, the second state machine in response to receiving the first encrypted request. The system increments, by the responder, the responder epoch value based on one or more of the indicated transaction number, the current responder epoch value, a state of the indicated transaction number in the second state machine, and a number of outstanding requests in a prior active epoch.

In another aspect, a computing system comprises a processing resource and a storage device storing instructions which when executed by the processing resource cause the processing resource to perform a method. The instructions or method may be performed by a requester or a responder, as described above in relation to, e.g., instructions 818 (including 820-832) in FIG. 8 and instructions 910-970 of FIG. 9. The computing system may also include additional instructions, including in relation to: the flowcharts of FIGS. 2E-H and 5A-D; the sliding windows of FIGS. 3 and 6; the state diagram of FIG. 4E; the operations in FIG. 7; and the instructions of CRM 900 in FIG. 9.

In another aspect, a non-transitory computer-readable storage medium (or CRM) stores instructions to perform a method. The instructions or method may be performed by a requester or a responder, as described above in relation to, e.g., instructions 818 (including 820-832) in FIG. 8 and instructions 910-970 of FIG. 9. The CRM may also include additional instructions, including in relation to: the flowcharts of FIGS. 2E-H and 5A-D; the sliding windows of FIGS. 3 and 6; the state diagram of FIG. 4E; the operations in FIG. 7; and the instructions of computing system 800 in FIG. 8.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

1. A computer-implemented method, comprising:
identifying, by a requester in a network fabric, a sliding window associated with:
a plurality of active epochs corresponding to a time window in which a predetermined number of requests are allowed to be sent; and
at least one inactive epoch corresponding to a time window in which requests are not allowed to be sent;
obtaining encryption keys associated with encryption of roundtrip communications with a responder;
generating an initial value (IV) associated with the encryption of the roundtrip communications, the IV comprising a current epoch value;
determining that the current epoch value differs from an epoch value used in a previously sent request;
advancing the sliding window;
responsive to the current epoch value matching a predetermined key-rolling value, rolling the encryption keys; and
sending, to the responder, a first request encrypted based on an obtained key associated with the current epoch value and indicating a subset of bits of the IV.

2. The method of claim 1,
wherein the encryption keys comprise:
a primary key associated with a most recent active epoch;
an alternate key associated with an oldest active epoch; and
a new key associated with a currently inactive epoch; and
wherein rolling the encryption keys comprises:
setting the primary key to a current value of the new key;
setting the alternate key to a current value of the primary key; and
setting the new key to a new value.

3. The method of claim 1, wherein the predetermined key-rolling value is based on at least one of:
a value agreed upon by the requester and the responder; or
messages exchanged between the requester and the responder.

4. The method of claim 1, wherein responsive to the current epoch value matching the predetermined key-rolling value, the method further comprises:
resetting the current epoch value to zero.

5. The method of claim 1, wherein the IV comprises:
most significant bits (MSBs) indicating an epoch value to be incremented by the requester or the responder; and
least significant bits (LSBs) indicating a transaction number.

6. The method of claim 1, further comprising:
sending encrypted requests to the responder and decrypting corresponding received responses from the responder, by the requester, in a same epoch corresponding to the current epoch value based on an obtained key associated with the current epoch.

7. The method of claim 1, further comprising:
maintaining, by the responder, a partial IV comprising a responder epoch value based on most significant bits of the IV;
obtaining, by the responder, the same keys obtained by the requester;
receiving, by the responder, the first encrypted request from the requester, wherein the indicated subset of bits comprises a transaction number;
determining, by the responder, whether to increment the responder epoch value based on one or more of:
one or more bits of the partial IV;
the transaction number;
the current responder epoch value;
a state associated with the transaction number; and
a number of requests outstanding in a prior active epoch; and
responsive to incrementing the responder epoch value:
advancing the sliding window; and
responsive to the current responder epoch value matching the predetermined key-rolling value, rolling the encryption keys, by the responder.

8. The method of claim 7, further comprising:
decrypting, by the responder, the first encrypted request from the requester, based on an obtained key associated with an epoch corresponding to the current responder epoch value; and
encrypting a corresponding response to the requester based on the obtained key.

9. The method of claim 8, further comprising:
maintaining, by the requester, a first state machine for each transaction number in a respective epoch, the first state machine tracking request issuance and response status for a respective transaction number across multiple epochs; and
incrementing, by the requester, the current epoch value based on:
sending the predetermined number of requests for a most recent active epoch; and
determining that outstanding responses have been received for all requests sent for an oldest active epoch.

10. The method of claim 9, further comprising:
maintaining, by the responder, a second state machine for each transaction number in an epoch,
the second state machine indicating two states based on whether a request is expected to be received by the responder in an even epoch or an odd epoch; and
updating, by the responder, the second state machine in response to receiving the first encrypted request; and
incrementing, by the responder, the responder epoch value based on one or more of the indicated transaction number, the current responder epoch value, a state of the indicated transaction number in the second state machine, and a number of outstanding requests in a prior active epoch.

11. A computing system comprising:
at least one processing resource; and
at least one storage device storing instructions which when executed by the at least one processing resource cause the at least one processing resource to perform a method, the method comprising:
identifying, by a requester in a network fabric, a sliding window associated with:
a plurality of active epochs corresponding to a time window in which a predetermined number of requests are allowed to be sent; and
at least one inactive epoch corresponding to a time window in which requests are not allowed to be sent;
obtaining encryption keys associated with encryption of roundtrip communications with a responder;
generating an initial value (IV) associated with the encryption of the roundtrip communications, the IV comprising a current epoch value;
determining that the current epoch value differs from an epoch value used in a previously sent request;
advancing the sliding window;
responsive to the current epoch value matching a predetermined key-20 rolling value, rolling the encryption keys; and
sending, to the responder, a first request encrypted based on an obtained key associated with the current epoch value and indicating a subset of bits of the IV.

12. The computing system of claim 11,
wherein the encryption keys comprise:
a primary key associated with a most recent active epoch;
an alternate key associated with an oldest active epoch; and
a new key associated with a currently inactive epoch; and
wherein rolling the encryption keys comprises:
setting the primary key to a current value of the new key;
setting the alternate key to a current value of the primary key; and
setting the new key to a new value.

13. The computing system of claim 11, wherein the predetermined key-rolling value is based on at least one of:
a value agreed upon by the requester and the responder; or
messages exchanged between the requester and the responder.

14. The computing system of claim 11, wherein responsive to the current epoch value matching the predetermined key-rolling value, the method further comprises:
resetting the current epoch value to zero.

15. The computing system of claim 11, wherein the IV comprises:
most significant bits (MSBs) indicating an epoch value to be incremented by the requester or the responder; and
least significant bits (LSBs) indicating a transaction number.

16. The computing system of claim 11, the method further comprising:
maintaining, by the responder, a partial IV comprising a responder epoch value based on most significant bits of the IV;
obtaining, by the responder, the same keys obtained by the requester;
receiving, by the responder, the first encrypted request from the requester, wherein the indicated subset of bits comprises a transaction number;
determining, by the responder, whether to increment the responder epoch value based on one or more of:
one or more bits of the partial IV;
the transaction number;
the current responder epoch value;
a state associated with the transaction number; and
a number of requests outstanding in a prior active epoch; and
responsive to incrementing the responder epoch value:
advancing the sliding window; and
responsive to the current responder epoch value matching the predetermined key-rolling value, rolling the encryption keys, by the responder.

17. The computing system of claim 16, the method further comprising:
decrypting, by the responder, the first encrypted request from the requester, based on an obtained key associated with an epoch corresponding to the current responder epoch value; and
encrypting a corresponding response to the requester based on the obtained key.

18. The computing system of claim 17, the method further comprising:
maintaining, by the requester, a first state machine for each transaction number in a respective epoch, the first state machine tracking request issuance and response status for a respective transaction number across multiple epochs; and
incrementing, by the requester, the current epoch value based on:
sending the predetermined number of requests for a most recent active epoch; and
determining that outstanding responses have been received for all requests sent for an oldest active epoch;
maintaining, by the responder, a second state machine for each transaction number in an epoch, the second state machine indicating two states based on whether a request is expected to be received by the responder in an even epoch or an odd epoch;
updating, by the responder, the second state machine in response to receiving the first encrypted request; and
incrementing, by the responder, the responder epoch value based on one or more of the indicated transaction number, the current responder epoch value, a state of the indicated transaction number in the second state machine, and a number of outstanding requests in a prior active epoch.

19. A non-transitory computer-readable medium storing instructions which when executed by a processing resource cause the processing resource to perform a method, the method comprising:
identifying, by a requester in a network fabric, a sliding window associated with:
plurality of active epochs corresponding to a time window in which a predetermined number of requests are allowed to be sent; and
at least one inactive epoch corresponding to a time window in which requests are not allowed to be sent;
obtaining encryption keys associated with encryption of roundtrip communications with a responder;
generating an initial value (IV) associated with the encryption of the roundtrip communications, the IV comprising a current epoch value;
determining that the current epoch value differs from an epoch value used in a previously sent request;
advancing the sliding window;
responsive to the current epoch value matching a predetermined key-rolling value, rolling the encryption keys; and
sending, to the responder, a first request encrypted based on an obtained key associated with the current epoch value and indicating a subset of bits of the IV.

20. The non-transitory computer-readable medium of claim 19,
wherein the encryption keys comprise:
a primary key associated with a most recent active epoch;
an alternate key associated with an oldest active epoch; and
a new key associated with a currently inactive epoch; and
wherein rolling the encryption keys comprises:
setting the primary key to a current value of the new key;
setting the alternate key to a current value of the primary key; and
setting the new key to a new value.
